(19) United States
(12) Patent Application Publication
(10) Pub. No.: US 2021/0064525 A1
(43) Pub. Date: Mar. 4, 2021

(54) HARDWARE-BASED VIRTUALIZATION OF INPUT/OUTPUT (I/O) MEMORY MANAGEMENT UNIT

(71) Applicant: Intel Corporation, Santa Clara, CA (US)

(72) Inventors: Kun Tian, Shanghai (CN); Rajesh Sankaran, Portland, OR (US); Sanjay Kumar, Hillsboro, OR (US); Ashok Raj, Portland, OR (US)

(73) Assignee: Intel Corporation, Santa Clara, CA (US)

(21) Appl. No.: 16/958,479

(22) PCT Filed: Jan. 2, 2018
(86) PCT No.: PCT/CN2018/070012

§ 371 Date: Jun. 26, 2020

(51) Int. Cl. G06F 12/06; G06F 12/1081; G06F 12/1036; G06F 12/0891; G06F 9/455

(52) U.S. Cl. CPC G06F 12/063; G06F 12/1081; G06F 12/1036; G06F 12/0891; G06F 2212/651; G06F 2009/45583; G06F 2212/151; G06F 2212/657; G06F 9/45558

(57) ABSTRACT

A processor includes a hardware input/output (I/O) memory management unit (IOMMU) and a core, which executes an instruction to intercept a payload from a virtual machine (VM). The payload contains a guest bus device function (BDF) identifier, a guest address space identifier (ASID), and a guest address range. The core accesses, within a virtual machine control structure stored in memory, pointers to a first set of translation tables and a second set of translation tables. The core traverses the first set of translation tables to translate the guest BDF identifier to a host BDF identifier and traverses the second set of translation tables to translate the guest ASID to a host ASID. The core stores the host BDF identifier and the host ASID in the payload and submits, to the hardware IOMMU, an administrative command containing the payload to perform invalidation of the guest address range.

### TECHNICAL FIELD

Aspects of the disclosure relate generally to virtualization within microprocessors, and more particularly, to hardware-based virtualization of an input/output (I/O) memory management unit.

### BACKGROUND

Virtualization allows multiple instances of an operating system (OS) to run on a single system platform. Virtualization is implemented by using software, such as a virtual machine monitor (VMM) or hypervisor, to present to each OS a “guest” or virtual machine (VM). The VM is a portion of software that, when executed on appropriate hardware, creates an environment allowing for the abstraction of an actual physical computer system also referred to as a “host” or “host machine.” On the host machine, the virtual machine monitor provides a variety of functions for the VMs, such as allocating and executing request by the virtual machines for the various resources of the host machine.

### BRIEF DESCRIPTION OF THE DRAWINGS

FIG. 1 is a block diagram of a computing system for hardware-based virtualization of an input/output (I/O) memory management unit (IOMMU), according to various implementations.

FIG. 2 is a block diagram of a system that includes a virtual machine control structure (VMCS) and set of bus device function (BDF) identifier translation tables used to translate a guest BDF identifier to a host BDF identifier, according to various implementations.

FIG. 3 is a block diagram illustrating a system including a memory for virtualization of process address space identifiers for I/O devices using dedicated work queues, according to one implementation.

FIG. 4 is a block diagram illustrating another system including a memory for virtualization of process address space identifiers for I/O devices using shared work queues according to one implementation.

FIG. 5A is a block diagram illustrating administrative descriptor command data structure, according to various implementations.

FIG. 5B is a block diagram illustrating an administrative completion record containing a status indicative of completion of the administrative descriptor command, according to one implementation.

FIG. 6 is a flow chart of a method of handling invalidations from a virtual machine with virtualization support from a hardware IOMMU, according to some implementations.

FIG. 7 is a block diagram of a computing system illustrating hardware-based virtualization of IOMMU to handle page requests, according to implementations.

FIG. 8A is a block diagram illustrating a page request descriptor, according to one implementation.

FIG. 8B is a block diagram illustrating a page group response descriptor, according to one implementation.

FIG. 9 is a flow chart of a method of handling page requests from I/O devices with virtualization support from a hardware IOMMU, according to some implementations.

FIG. 10A is a block diagram illustrating a micro-architecture for a processor or an integrated circuit that may implement hardware-based virtualization of an IOMMU, according to an implementation.

FIG. 10B is a block diagram illustrating an in-order pipeline and a register renaming stage, out-of-order issue/execution pipeline that may implement hardware-based virtualization of an IOMMU, according to one implementation.

FIG. 11 illustrates a block diagram of the micro-architecture for a processor or an integrated circuit that may implement hardware-based virtualization of an IOMMU, according to an implementation.

FIG. 12 is a block diagram of a computer system that may implement hardware-based virtualization of an IOMMU, according to one implementation.

FIG. 13 is a block diagram of a computer system according that may implement hardware-based virtualization of an IOMMU to another implementation.

FIG. 14 is a block diagram of a system-on-a-chip (SoC) that may implement hardware-based virtualization of an IOMMU according to one implementation.

FIG. 15 illustrates another implementation of a block diagram for a computing system that may implement hardware-based virtualization of an IOMMU.

FIG. 16 is a block diagram of processing components for executing instructions that may implement hardware-based virtualization of an IOMMU, according one implementation.

FIG. 17A is a flow diagram of an example method to be performed by a processor to execute an instruction to submit work to a shared work queue (SWQ), according to one implementation.

FIG. 17B is a flow diagram of an example method to be performed by a processor to execute an instruction to handle invalidations from a VM with support from a hardware IOMMU, according to one implementation.

FIG. 18 is a block diagram illustrating an example format for instructions disclosed herein.

FIG. 19 illustrates another implementation of a block diagram for a computing system that may implement hardware-based virtualization of an IOMMU.

### DETAILED DESCRIPTION

An I/O memory management unit (IOMMU) within a processor provides isolation and protection from I/O devices performing direct memory access (DMA) to system memory. Without the presence of IOMMU, errant or rouge I/O devices may corrupt system memory because the I/O devices may otherwise have unrestrained access to system memory. With advances in I/O device virtualization such as Peripheral Component Interconnect Express (PCI-e®) single-root I/O virtualization (SR-IOV), the IOMMU may also facilitate direct assignment of devices to a guest operating system (OS) running on a virtual machine (VM). This allows a native, unmodified guest device driver to interact directly with hardware without orchestrating interaction with the I/O device.

Recent developments in I/O such as shared virtual Memory (SVM) allows fast accelerator devices (e.g., graphics and field programmable gate array (FPGA)), to be directly controlled by user space processes. This SVM and the process address space identifier (PASID, or simply “ASID”) specified in the PCI-SIG® require no pinning of DMA memory, and the I/O device can co-operatively work with the OS to perform on demand paging of memory when its needed. In a cloud environment, architecture design may make accessible, to a guest OS, these types of accelerator devices and be capable of accessing the same device level I/O directly from within user programs running inside a guest OS image. Allowing use of SVM-capable devices may require an IOMMU (e.g., a guest IOMMU driver) inside the guest in order to provide protection for DMA accesses.

A system platform may have one or more IOMMU agents in the system. When exposing devices behind an IOMMU to a guest, virtualization software such as a virtual machine monitor (VMM) may provide a facility to virtualize the IOMMU to the guest, e.g., create a guest IOMMU (also referred to as a virtual IOMMU). The guest OS may then function, through the guest IOMMU, discover the direct-assigned device behind the hardware IOMMU that enforces DMA access to memory from within the guest OS. Interacting from the user process to end I/O devices may require the guest OS to perform invalidations when the guest OS is changing virtual memory mappings for that process. Similarly when a device attempts to perform DMA, but the pages are not present, this generates a page fault for the device. The I/O devices that support page request service (PRS) can send a page request to the hardware IOMMU (e.g., physical IOMMU) to resolve the page fault. Such page request services are forwarded from the physical IOMMU (pIOMMU) to the virtual IOMMU (vIOMMU) running in the guest.

The hardware IOMMU may provide, within the architecture, circuitry and/or logic that facilitates the VMM to trap during these IOMMU interactions and allow the hardware IOMMU driver to proxy those operations on behalf of the vIOMMU. To “trap” means that the VM of the guest OS exits to the VMM, which executes the pIOMMU driver to emulate the hardware IOMMU. In this way, the VM exit allows the VMM to perform the proxy operations on behalf of the vIOMMU in the guest OS. Once the operations have completed, the VMM may cause re-entry to the VM. These VM exits and entries (e.g., traps or interception) introduce latency in the system operation and therefore may cause significant overhead just for the IOMMU virtualization required within a guest OS of a VM. For example, when a guest OS may frequently performs an I/O translation lookaside (TLB) or device TLB invalidation, frequently pass events such as page requests directly to the guest OS, and frequently pass page responses directly to the hardware IOMMU, the system may incur substantial performance overhead due to virtualization of the IOMMU within a VM.

Accordingly, the disclosed implementations reduce this performance overhead for the above-noted types of vIOMMU-based functions by offloading these functions to the hardware IOMMU, and thus avoid the VM exits and entries that cause the greatest overhead hits. These implementations may also enhance scalability when several VMs are being hosted in a single system.

More specifically, in one implementation, a processor may include a hardware input/output (I/O) memory management unit (IOMMU), which may also be referred to as a pIOMMU, and a core coupled to the hardware IOMMU. The core may execute a guest IOMMU driver within a virtual machine (VM). When the VM encounters a need to invalidate a guest address range, the guest IOMMU driver may populate a descriptor payload with a guest bus device function (BDF) identifier, a guest address space identifier (ASID), and a guest address range to be invalidated. The descriptor payload may be associated with an administrative command, supervisor mode (ADMCMDS) instruction, which the guest IOMMU driver may call for execution. The “supervisor mode” aspect of the ADMCMDS instruction may be with reference to execution from the guest kernel level, e.g., which operates within the ring-0 privilege level.

In various implementations, the core may execute the ADMCMDS instruction to intercept the descriptor payload from the VM. The core may access, within a virtual machine control structure (VMCS) for the VM stored in memory, a first pointer to a first set of translation tables. In one implementation, the first pointer is a BDF table pointer and the first set of translations tables is a set of BDF translation tables. The core may traverse the first set of translation tables to translate the guest BDF identifier to a host BDF identifier. The core may further access, within the VMCS, a second pointer to a second set of translation tables. In one implementation, the second pointer is an address space identifier (ASID) table pointer and the second set of translation tables are ASID translation tables. The core may traverse the second set of translation tables to translate the guest ASID to a host ASID, and store the host BDF identifier and the host ASID in the descriptor payload. The core may then submit, to the hardware IOMMU, an administrative command containing the payload to perform invalidation of the guest address range. The hardware IOMMU may then complete an invalidation operation with reference to the guest address range.

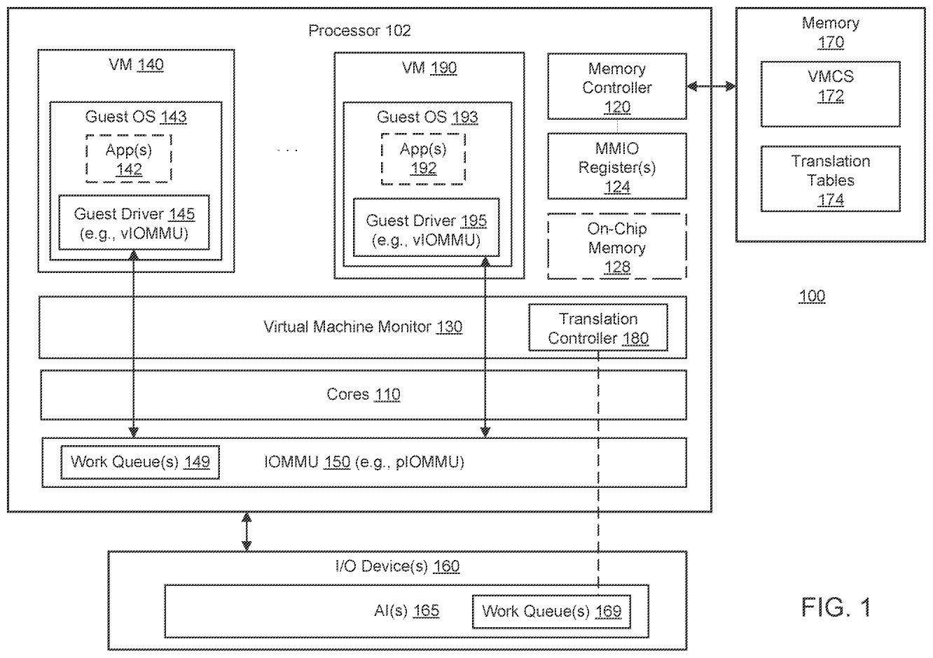

FIG. 1 is a block diagram of a computing system 100 for hardware-based virtualization of an input/output (I/O) memory management unit (IOMMU), according to various implementations. The computing system 100 may include, but not be limited to, a processor 102 coupled to one or more I/O devices 160 and to memory 170 (e.g., system memory or main memory). The processor 102 may also be referred to as “CPU.” “Processor” or “CPU” herein shall refer to a device capable of executing instructions encoding logical or I/O operations. In one illustrative example, a processor may include an arithmetic logic unit (ALU), a control unit, and a plurality of registers. In a further aspect, a processor may include one or more processing cores, and hence may be a single core processor which is capable of processing a single instruction pipeline, or a multi-core processor which may simultaneously process multiple instruction pipelines. In another aspect, a processor may be implemented as a single integrated circuit, two or more integrated circuits, or may be a component of a multi-chip module (e.g., in which individual microprocessor dies are included in a single integrated circuit package and hence share a single socket).

The memory 170 may be understood to be off-chip system memory, e.g., main memory, which includes a volatile memory and/or a non-volatile memory. In various implementations, the memory 170 may store a virtual machine control structure (VMCS) 172 and translation tables 174. In one example, a set of the translation tables 174 may be stored within the VMCS 172, and therefore, the delineating data structures within the memory 170 is not intended to be limiting. In an alternative example, the translation tables are stored in the on-chip memory.

As shown in FIG. 1, the processor 102 may include various components. In one implementation, the processor 102 may include one or more processors cores 110 and a memory controller unit 120, among other components, coupled to each other as shown. The memory controller 120 may perform functions that enable the processor 102 to access and communicate with the memory 170. The processor 102 may also include a communication component (not shown) that may be used for point-to-point communication between various components of the processor 102. The processor 102 may be used in the computing system 100 that includes, but is not limited to, a desktop computer, a tablet computer, a laptop computer, a netbook, a notebook computer, a personal digital assistant (PDA), a server, a workstation, a cellular telephone, a mobile computing device, a smart phone, an Internet appliance or any other type of computing device. In another implementation, the processor 102 may be used in a system on a chip (SoC) system. In one implementation, the SoC may comprise the processor 102 and the memory 170. The memory for one such system may be DRAM memory. The DRAM memory may be located on the same chip as the processor and other system components. Additionally, other logic blocks such as a memory controller or graphics controller can also be located on the chip.

In an illustrative example, processing core 110 may have a micro-architecture including processor logic and circuits. Processor cores with different micro-architectures may share at least a portion of a common instruction set. For example, similar register architectures may be implemented in different ways in different micro-architectures using various techniques, including dedicated physical registers, one or more dynamically allocated physical registers using a register renaming mechanism (e.g., the use of a register alias table (RAT), a reorder buffer (ROB) and a retirement register file).

The processor core(s) 110 may execute instructions for the processor 102. The instructions may include, but are not limited to, pre-fetch logic to fetch instructions, decode logic to decode the instructions, execution logic to execute instructions and the like. The processor cores 110 include a cache (not shown) to cache instructions and/or data. The cache includes, but is not limited to, a level one, level two, and a last level cache (LLC), or any other configuration of the cache memory within the processor 102. The processor core 110 may be used with a computing system on a single integrated circuit (IC) chip of the computing system 100. The computing system 100 may be representative of processing systems based on the Pentium® family of processors and/or microprocessors available from Intel® Corporation of Santa Clara, Calif., although other systems (including computing devices having other microprocessors, engineering workstations, set-top boxes and the like) may also be used. In one implementation, a sample computing system may execute a version of an operating system, embedded software, and/or graphical user interfaces. Thus, implementations of the disclosure are not limited to any specific combination of hardware circuitry and software.

In various implementations, the processor 102 may further include memory-mapped I/O register(s) 124, on-chip memory 128 (e.g., volatile, flash, or other type of programmable memory), a virtual machine monitor (VMM) 130 (or hypervisor), one or more virtual machines (VM), identified as VM 140 through VM 190 in FIG. 1, and a hardware IOMMU 150, which is also known as a physical or pIOMMU. The VM 140 may execute a guest OS 143 within which may be run a number of applications 142 and one or more guest driver 145. The VM 190 may execute a guest OS 193 on which may be run a number of applications 192 and one or more guest driver 195. The processor 102 may include one or more additional virtual machines. Each guest driver 145 or 195 may, in one example, be a virtual IOMMU (vIOMMU) driver that may interact with the VMM 130 and the hardware IOMMU 150. The VMM 130 may further include a translation controller 180.

With further reference to FIG. 1, the VMM 130 may abstract a physical layer of a hardware platform of a host machine that may include the processor 102, and present this abstraction to the guests or virtual machines (VMs) 140 or 190. The VMM 130 may provide a virtual operating platform for the VMs 140 through 190 and manages the execution of the VMs 140 through 190. In some implementations, more than one VMM may be provided to support the VMs 140 through 190 of the processor 102. Each VM 140 or 190 may be a software implementation of a machine that executes programs as though it was an actual physical machine. The programs may include the guest OS 143 or 193, and other types of software and/or applications, e.g., applications 142 and 192, respectively running on the guest OS 143 and guest OS 193.

In some implementations, the hardware IOMMU 150 may enable the VMs 140 and 190 to use the I/O devices 160, such as Ethernet hardware, accelerated graphics cards, and hard-drive controllers, which may be coupled to the processor 102, e.g., by way of a printed circuit board (PCB) or an interconnect that is placed on or located off of the PCB. To communicate operations between virtual machines VMs 140 through 190 and I/O devices 160, the hardware IOMMU translates addresses between physical memory addresses of the I/O devices 160 and virtual memory addresses of the VMs 140, 190. For example, the hardware IOMMU 150 may be communicably coupled to the processing cores 110 and the memory 170 via the memory controller 120, and may map the virtual addresses of the VMs 140 through 190 to the physical addresses of the I/O devices 160 in memory.

Each of the I/O devices 160, in implementations, may include one or more assignable interfaces (AIs) 165 for each hosting function supported by respective I/O device. Each of the AIs 165 supports one or more work submission interfaces. These interfaces enable a guest driver, such as guest drivers 145 and 195, of the VMs 140 and 190 to submit work directly to the AIs 165 of the I/O devices 160 without host software intervention by the VMM 130. The type of work submission to AIs is device-specific, but may include a dedicated work queue (DWQ) and/or shared work queue (SWQ) based work submissions. In some examples, the work queue 169 may be a ring, a linked list, an array or any other data structure used by the I/O devices 160 to queue work from software. The work queues 169 are logically composed of work-descriptor storage (that convey the commands, operands for the work), and may be implemented with explicit or implicit doorbell registers (e.g., ring tail register) or portal registers to inform the I/O device 160 about new work submission. The work-queues 169 may be hosted in main memory, device private memory, or in on-device storage, e.g., on-chip memory 128.

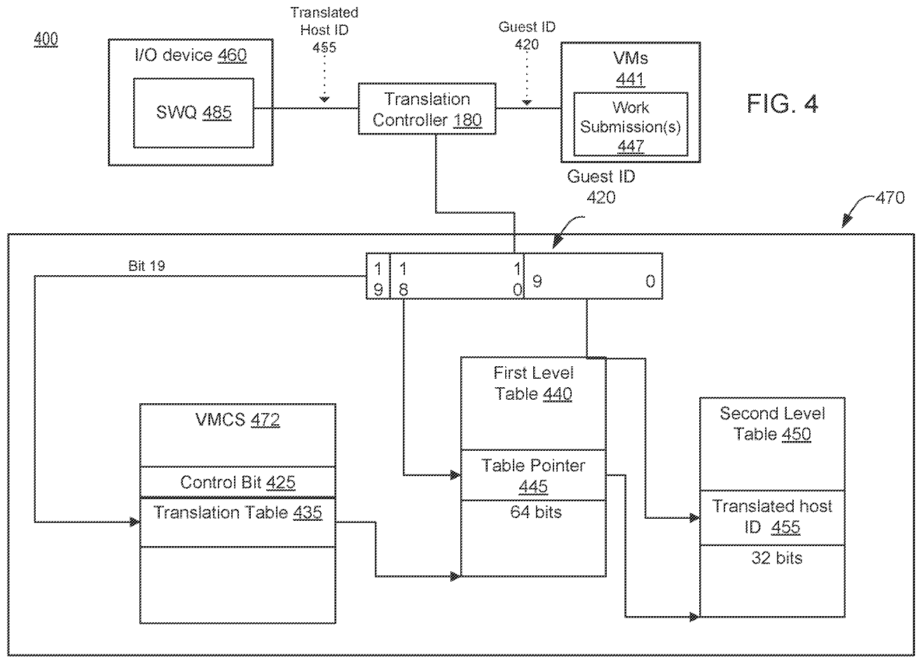

The VMs may submit work to SWQ on the CPU (e.g., processor 102) using certain instructions, such as an Enqueue Command (ENQCMD) or an Enqueue Command as Supervisor (ENQCMDS) instructions, which will be discussed in more detail with reference to FIG. 4. An ENQCMD instruction may be executed from any privilege-level, while ENQCMDS instructions are restricted to supervisor-privileged (Ring-0) software. These processor instructions may be “general purpose” in the sense that they can be used to queue work to SWQ(s) of any devices agnostic/transparent to the type of device to which the command is targeted.

In some implementations, the I/O devices 160 may be configured to issue memory requests, such as memory read and write requests, to access memory locations in the memory and in some cases, translation requests. The memory requests may be part of a direct memory access (DMA) read or write operation, for example. The DMA operations may be initiated by software executed by the processor 102 directly or indirectly to perform the DMA operations. Depending on the address space in which the software executing on the processor 102 is running, the I/O devices 160 may be provided with addresses corresponding to that address space to access the memory. For example, a guest application (e.g., application 142) executing on processor 102 may provide an I/O device 160 with guest virtual addresses (GVAs). When the I/O device 160 requests a memory access, the guest virtual addresses may be translated by the hardware IOMMU 150 to corresponding host physical addresses (HPA) to access the memory, and the host physical addresses may be provided to the memory controller 120 for access.

To manage the guest-to-host ASID translation associated with work from the work queues 169, the processor 102 may implement a translation controller 180 also referred to herein as an address translation circuit. For example, the translation controller 180 may be implemented as part of the VMM 130. In alternative implementations, the translation controller 180 may be implemented in a separate hardware component, circuitry, dedicated logic, programmable logic, and microcode of the processor 102 or any combination thereof. In one implementation, the translation controller 180 may include a micro-architecture including processor logic and circuits similar to the processing cores 110. In some implementations, the translation controller 180 may include a dedicated portion of the same processor logic and circuits used by the processing cores 110.

In a further implementation, and with additional reference to FIG. 1, the hardware IOMMU 150 may also support work queue(s) 149 similar to the work queue(s) 169 of the I/O devices 160. For example, the work queue(s) 149 may include a SWQ to which the multiple virtual machines may transmit work submissions. For example, the multiple guest IOMMU drivers (of the multiple VMs) may submit descriptor payloads to the SWQ of the hardware IOMMU 150. The descriptor payloads may include a guest bus device function (BDF) identifier, a guest ASID, and a guest address range to be invalidated.

In various implementations, a descriptor payload is associated with an administrative command, supervisor mode (ADMCMDS) instruction, which a guest IOMMU driver (e.g., guest driver 145 or 195) may call for execution by a core 110, e.g., CPU. The guest IOMMU driver may also populate the descriptor payload with the guest BDF identifier, the guest ASID, and the guest address range.

The core 110 may execute the ADMCMDS instruction to perform an ENQCMDS-like operation to submit the descriptor payload to the SWQ of the hardware IOMMU 150. The SWQ may include a payload buffer which buffers descriptor payloads and handles them in turn (as will be discussed in more detail with reference to FIG. 4). The ADMCMDS instruction may also cause the core to translate the guest BDF to host BDF and the guest ASID to host ASID, both of which may be inserted into the descriptor payload. As the descriptor payload exits the SWQ, the core may form an administrative command out of the descriptor payload, which is transmitted to the hardware IOMMU 150. The administrative command may thus contain the descriptor payload that the hardware IOMMU 150 will access to perform IOTLB and/or device TLB invalidations to invalidate the guest address range at the hardware IOMMU 150 and or at one or more I/O devices 160. The hardware address range may include one or more virtual addresses that the VM is now reallocating.

In one implementation, the guest IOMMU driver may access a particular MMIO register within the MMIO registers 124 of the processor 102. The particular MMIO register may contain a MMIO register address to which to submit each descriptor payload to reach the SWQ associated with the hardware IOMMU 150. The SWQ may then handle the descriptor commands from various virtual machines similar to the way the SWQ of the work queues 169 of the I/O devices 160 do in response to the ENQCMDS, which will be discussed in more detail.

In various implementations, the VMM 130 may perform the guest to host translations of the guest BDF identifier and the guest ASID and store these translations in the translations tables 174. The VMM 130 may also store a pointer in the VMCS 172 associated with a particular VM to point to a first level table of a set of nested translations tables for translations set up ahead of time by the VMM 130. Note that the VMCS 172 may include each of such pointers for the VM so that the core, in executing the ADMCMDS instruction, knows where to find these pointers. The translations tables 174, in alternative implementations, may be stored in the VMCS 172, in context PASID tables, in extended context PASID tables, or in the on-chip memory 128. Accordingly, the location of each set of nested translation tables may vary.

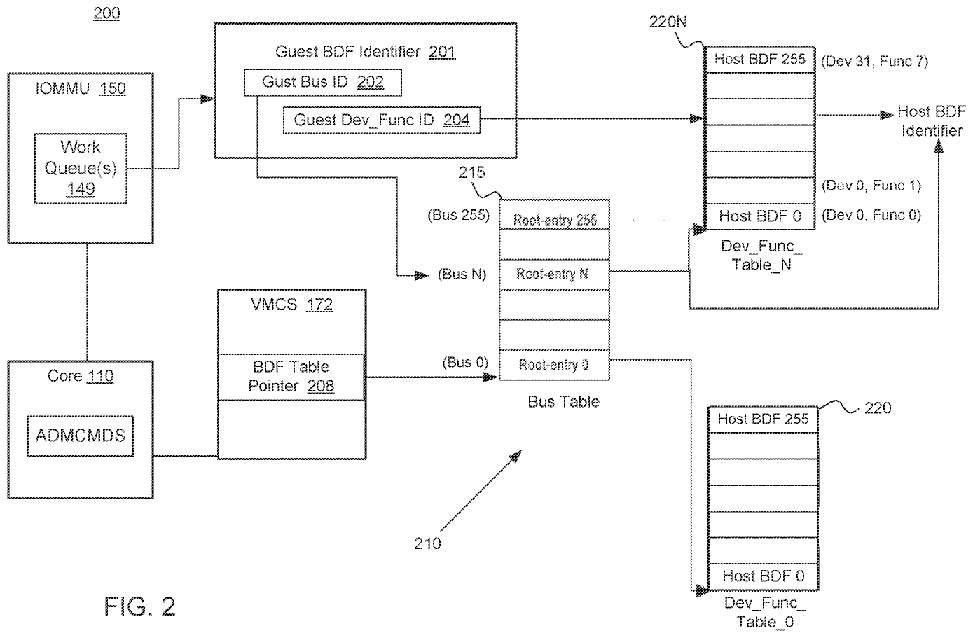

FIG. 2 is a block diagram of a system 200 that includes a set of bus device function (BDF) identifier translation tables 210 used to translate a guest BDF identifier to a host BDF identifier, according to various implementations. In one implementation, the core 110 executes the ADMCMDS instruction, which may cause the core to access the BDF table pointer 208 in the VMCS 172. The BDF table pointer 208 may point to a first table (e.g., a bus table 215) of the set of BDF translation tables 210. Note that the set of BDF translation tables 210 may also be stored in the VMCS 172, which the core 110 may traverse (e.g., walk) to translate an incoming guest BDF identifier. In other implementations, the translation tables 210 are stored with the other translation tables 174.

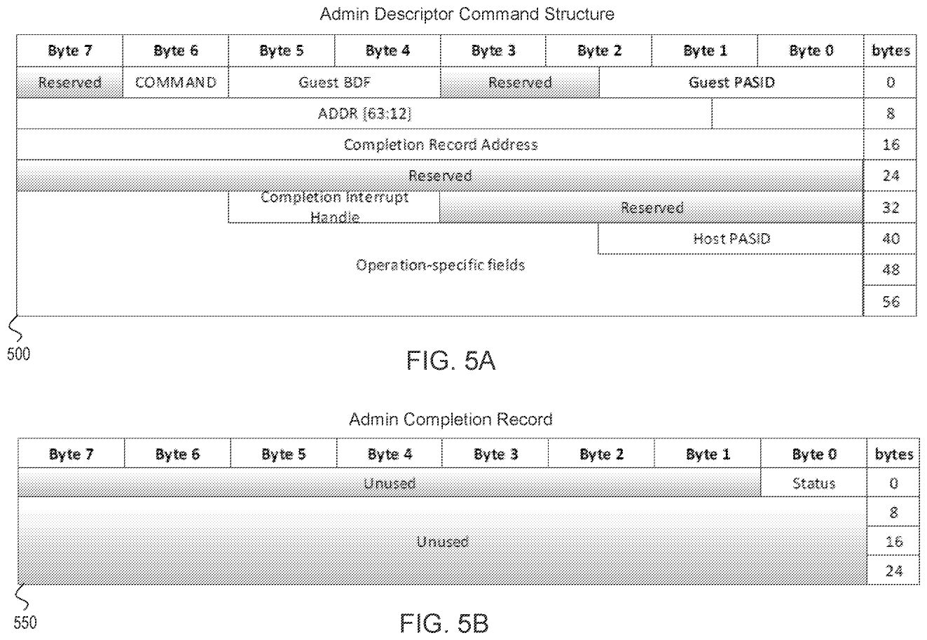

The core 110 may also access the next descriptor payload in the SWQ of the hardware IOMMU 150, and read out the guest BDF identifier 201. An example descriptor payload is illustrated in FIG. 5A (see bytes 4 and 5 of row_0). The first byte of the guest BDF identifier 201 may be a guest bus identifier (ID) 202 and the second byte may be a guest device-function ID 204, for example. The core 110 may then index within the bus table 215 to locate the entry for the bus associated with the guest bus ID 202, which entry is the host Bus_N, e.g., the host bus identifier translated from the guest bus ID 202.

The core 110 may then use the root entry N (the host bus ID) of the bus table 215 as a pointer to the correct device-function table of a set of second translation tables, e.g., device-function table 220 to device-function table 220N. The core 110 may read out the guest device-function identifier (ID) 204 from the descriptor payload and index within the device-function table 220N to which the host bus ID points according to the device-function ID 204. The indexed location within the device-function table 220N may store a host device identifier and a host function identifier translated from the guest device-function ID 204, which when combined with the host bus ID, results in the translated host BDF identifier.

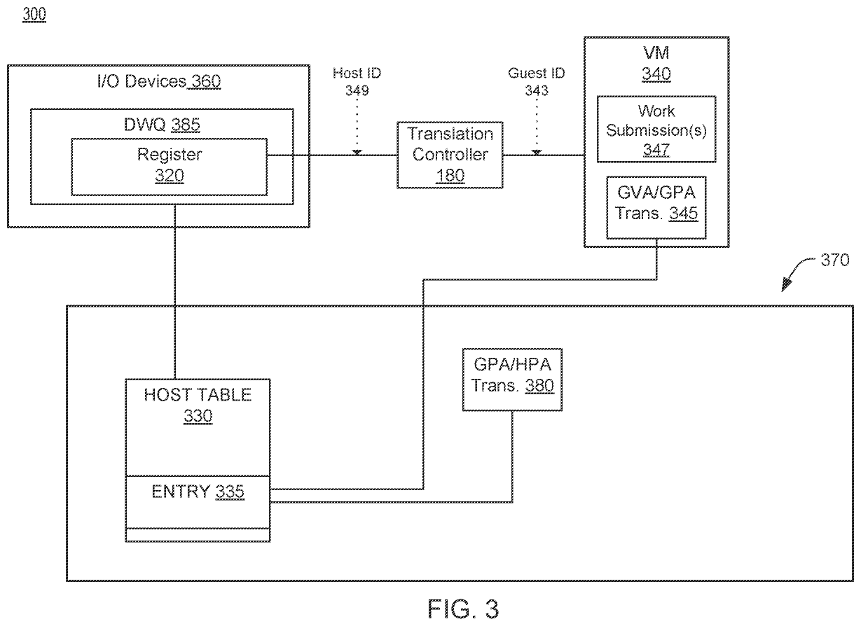

FIG. 3 illustrates a block diagram of a system 300 including a memory 370 for managing translation of process address space identifiers for scalable virtualization of input/output devices according to one implementation. The system 300 may be compared to the processor 102 of FIG. 1. As shown, the system 300 includes the translation controller 180 of FIG. 1, a VM 340 (which may be compared to the VMs 140,190 of FIG. 1) and an I/O device 360 (which may be compared to the I/O devices 160 of FIG. 1). In this example, the I/O device 360 supports one or more dedicated work queues, such as DWQ 385. A DWQ 385 is a queue that is used by only one software entity for the computing system 100. For example, the DWQ 385 may be assigned to a single VM, such as VM 340. The DWQ 385 includes an associated ASID register 320 (e.g., a ASID MMIO register) which can be programmed by the VM with a guest ASID 343 associated with the VM 340, which should be used to process work from the DWQ. The guest driver in the VM 340 may further assign the DWQ 385 to a single kernel mode or user mode client that may use shared virtual memory (SVM) to submit work directly to the DWQ 385.

In some implementations, the translation controller 180 of the VMM intercepts a request from the VM 340 to configure the guest ASID 343 to the DWQ 385. For example, the translation controller 180 may intercept an attempt by the VM 340 to configure the ASID register 320 of the DWQ 385 with guest ASID 343 and instead sets the ASID register 320 with a host ASID 349. In this regard, when a work submission 347 is received from the VM 304 (e.g., from a SVM client via guest driver 145, 195) for the I/O device 360, the host ASID 349 from the ASID register 320 of the DWQ 385 is used for the work submission 347. For example, the VMM allocates a host ASID 349 and programs it in a host ASID table 330 of the physical IOMMU's for nested translation using pointers 345 to a first level (GVA→GPA) translation table and pointer 380 to a second level (GPA→HPA) translation table. The host ASID table 330 may be indexed by using the host ASID 349 of the VM 340. The translation controller 180 configures the host ASID in ASID register 320 of the DWQ 385. This enables the VM to submit commands directly to an AI of the I/O device 360 without further traps to the translation controller 180 of the VMM and enables the DWQ to use the host ASID to send DMA requests to the IOMMU for translation.

The address, in some implementations, may be a GVA associated with the VM 340's application. The I/O device 360 may then send a DMA request with the GVA to be translated by the hardware IOMMU 150. When a DMA request or a translation request including a GVA is received from the I/O device 360, the request may include an ASID tag that is used to index the host ASID table 330. The ASID tag may identify an ASID entry 335 in the host ASID table 330 and may perform a nested 2-level translation of the GVA associated with the request to HPA. For example, the ASID entry 335 may include a first address pointer to a base address of CPU page table that is setup by the VM 340 GVA→GPA translation pointer 345. The ASID entry 335 may also include a second address pointer to a base address of a translation table that is setup by the IOMMU driver of the VMM to perform a GPA→HPA translation 380 of the address to a physical page in the memory 370.

FIG. 4 illustrates a block diagram of another system 400 including a memory 470 for managing translation of process address space identifiers for scalable virtualization of I/O devices according to one implementation. The system 400 may be compared to the computing system 100 of FIG. 1. For example, the system 400 includes the translation controller 180 of FIG. 1, a plurality of VMs 441 (which may be compared to the VMs 140 and 190 of FIG. 1 and the VM 240 of FIG. 1) and an I/O device 460 (which may be compared to the I/O devices 160 of FIG. 1 and the I/O device 250 of FIG. 2). In this example, work submissions 447 to the I/O device 460 are implemented using a shared work queue (SWQ) 485. The SWQ 485 can be used by more than one software entity simultaneously, such as by the VMs 441. The I/O device 460 may support any number of SWQs 485. A SWQ may be shared among multiple VMs (e.g., guest drivers). The guest driver in the VMs 441 may further share the SWQ with other kernel mode and user mode clients within the VMs, which may use shared virtual memory (SVM) to submit work directly to the SWQ.

In some implementations, the VMs 441 submits work to SWQ on the CPU (e.g., processor 102) using certain instructions, such as an Enqueue Command (ENQCMD), an Enqueue Command as Supervisor (ENQCMDS) instruction, or an ADMCMDS instruction. The ENQCMD instruction may be executed from any privilege-level, while ENQCMDS may be restricted to supervisor-privileged (Ring-0) software. These processor instructions are “general purpose” in the sense that they can be used to queue work to SWQ(s) of any devices agnostic/transparent to the type of device to which the command is targeted. These instructions produce an atomic non-posted write transaction (a write transaction for which a completion response is returned back to the processing device). The non-posted write transaction is address routed like any normal MMIO write to the target device. The non-posted write transaction carries with it the ASID of the thread/process that is submitting this request. It also carries with it the privilege (ring-3 or ring-0) at which the instruction was executed on the host. It also carries a command payload that is specific to target device. These SWQs are typically implemented with work-queue storage on the I/O device but may also be implemented using off-device (host memory) storage.

Unlike DWQs (where the ASID identity of the software entity to which it is assigned is programmed by the host driver (e.g., translation controller 180)), the SWQ 485 (due to its shared nature) does not have a pre-programmable ASID register. Instead, the ASID allocated to the software entity (application, container, or VMs 441, to include vIOMMU drivers with the VMs 441) executing the ENQCMD/S instruction is conveyed by the processor 102 as part of the work submission 447 transaction generated by the ENQCMD/S instruction. The guest ASID 420 in the ENQCMD/S transaction may be translated to a host ASID in order for it to be used by the endpoint device (e.g., I/O device 460) as the identity of the software entity for upstream transactions generated for processing the respective work item.

To translate a guest ASID 420 to host ASID, the system 400 may implement an ASID translation table 435 in the hardware-managed per-VM state structure also referred to as the VMCS 472. The VMCS 472 may be stored in a region of memory and contains, for example, state of the guest, state of the VMM, and control information indicating under which conditions the VMM wishes to regain control during guest execution. The VMM can set up the ASID translation table 435 in the VMCS 472 to translate a guest ASID 420 to host ASID as part of the SWQ execution. The ASID translation table 435 may be implemented as a single level or multi-level table that is indexed by guest ASID 420 that is contained in the work descriptor submitted to the SWQ 485.

In some implementations, the guest ASID 420 comprises a plurality of bits that are used for the translation of the guest ASID. The bits may include, for example, bits that are used to identify an entry in the first level ASID translation table 440, and bits that are used to identify an entry in the second level ASID translation table 450. The VMCS 472 may also contain a control bit 425, which controls the ASID translation. For example, if the ASID control bit is set to a value of 0, ASID translation is disabled and the guest ASID is used. If the control bit is set to a value other than 0, ASID translation is enabled and the ASID translation table is used to translate the guest ASID 420 to a host ASID. In this regard, the translation controller 180 of the VMM sets the control bit 425 to enable or disable the translation. In some implementations, the VMCS 472 may implement the control bit as a ASID translation VMX execution control bit, which may be enabled/disabled by the VMM.

When ENQCMD/S instructions are executed in non-root mode and the control bit 425 is enabled, the system 400 attempts to translate the guest ASID 420 in the work descriptor to a host ASID using the ASID translation table 435. In some implementations, the system 400 may use the bit 19 in the Guest ASID as an index into the VMCS 472 to identify the (two entry) ASID translation table 435. In one implementation, the ASID translation table 435 may include a pointer to base address of the first level ASID table 440. The first level ASID table 440 may be indexed by the guest ASID (bits 18:10) to identify a ASID table pointer 445 to a base address of the second level ASID table 450, which is indexed by the Guest ASID (bits 9:0) to find the translated host ASID 455.

If a translation is found, the guest ASID 420 is replaced with the translated host ASID 455 (e.g., in the work descriptor and enqueued to the SWQ). If the translation is not found, it causes a VMExit. The VMM creates a translation from the guest ASID to a host ASID in the ASID translation table as part of VMExit handling. After VMM handles the VMExit, the VM 441 is resumed and the instruction is retried. On subsequent executions of ENQCMD or ENQCMDS instructions (or ADMCMDS instruction) by the SVM client, the system 400 may successfully find the host ASID in the ASID translation table 435. The SWQ receives the work descriptor with the host ASID and uses the host ASID to send address translation requests to the IOMMU (such as hardware IOMMU 150 of FIG. 1) to translate the guest virtual address (GVA) to a host physical address (HPA) that corresponds to a physical page in the memory 470.

When the VMExit occurs, the VMM checks the guest ASID in the virtual IOMMU's ASID table. If the guest ASID is configured in the virtual IOMMU, the VMM allocates a new host ASID and sets up the ASID translation table 435 in the VMCS 472 to map the guest ASID to the host ASID. The VMM also sets up the host ASID in the physical IOMMU for nested translation using the first level (GVA→GPA) and second level (GPA→HPA) translation (shown in FIG. 4 within the memory 470).

If the guest ASID is not configured in the virtual IOMMU, the VMM may treat it as an error and either injects a fault into the VM or suspends the VM. Alternatively, the VMM may configure a host ASID in the IOMMU's ASID table without setting up its first and second level translation pointers. When an I/O device uses the host ASID for DMA translation requests, the I/O device causes an address translation failure, which in turn causes the I/O device to issue PRS (Page Request Service) requests to the VMM. These PRS requests for the un-configured guest ASID can be injected into the VM to be handled in a VM-specific way. The VM may either configure the guest ASID in response or treat the PRS as an error and perform error-related handling.

Note that the translation of the guest ASID to the host ASID set up by the VMM 130 as illustrated in FIG. 4 may also be employed by the processor 102 in execution of the ADMCMDS instruction. For example, the core 110 may execute the ADMCMDS instruction and in addition to translating the guest BDF identifier to a host BDF identifier as in FIG. 2, also translate the guest ASID to a host ASID and insert the host ASID within the descriptor payload, as will be discussed with reference to FIG. 5A. In one implementation, the core 110 replaces the guest ASID with the host ASID within the administrative command data structure, which is generally referred to herein as the descriptor payload.

FIG. 5A is a block diagram illustrating administrative descriptor command data structure 500, according to various implementations, which incorporates the descriptor payload to which is previously referred. FIG. 5B is a block diagram illustrating an administrative completion record 550 containing a status indicative of completion of the administrative command, according to one implementation. The administrative descriptor command data structure 500 may include up to 8 bytes of data in each row and contain multiple rows of data. Although certain types of data are illustrated in certain rows, in other implementations, the data may be stored elsewhere within the administrative descriptor command data structure 500 than as illustrated.

In various implementations, the administrative descriptor command data structure 500 may be populated by the guest IOMMU driver (vIOMMU) of a VM for a particular invalidation request. For example, the guest IOMMU driver may insert the guest BDF, the guest ASID (illustrated as PASID) and the guest address range (illustrated as ADDR −63:12]) to be invalidated. The third rows illustrates a completion record address, which is a location in memory where the virtual IOMMU driver may access the administration completion record 550 illustrated in FIG. 5B, which contains a status related to completion of the invalidation. In one implementation, the status may be a binary yes or no in relation to a successful completion (or not) of the invalidation operation performed by the hardware IOMMU 150.

Note that the administrative descriptor command data structure 500 thus may include the descriptor payload information (guest BDF identifier, guest ASID, and guest address range to be invalidated) as well as the data generated by the core 110 during execution of the ADMCMDS instruction. For example, the core 110 may insert the host ASID and the host BDF identifier into the descriptor payload of administrative descriptor command data structure 500. In one implementation, the guest BDF identifier is replaced with the host BDF identifier as once the administrative descriptor command data structure 500 issued as a command to the hardware IOMMU 150, the guest BDF identifier may no longer be useful.

In various implementations, as the descriptor payload is handled in relation to the SWQ of the hardware IOMMU, the core 110 ultimately issues an administrative command to the hardware IOMMU 150 that includes the administrative descriptor command data structure 500, and thus the descriptor payload as well. The hardware IOMMU 150 may then use the host BDF identifier and the host ASID within the descriptor payload of the administrative command to perform an invalidation operation with relation to the guest address range. The invalidation operation is at least one of an I/O translation lookaside buffer (IOTLB) invalidation, a device TLB invalidation, or an ASID cache invalidation. Related to the latter, when a guest OS performs a cache invalidation for a guest ASID, the hardware IOMMU 150 may perform a cache invalidation for a corresponding host ASID. When the one or more invalidation operation is complete, e.g., either successfully or unsuccessfully, the hardware IOMMU 150 may set the status bit within the administrative completion record 550. The guest IOMMU driver of the VM may access the administrative completion record 550 at the address previously inserted in the administrative descriptor command data structure 500.

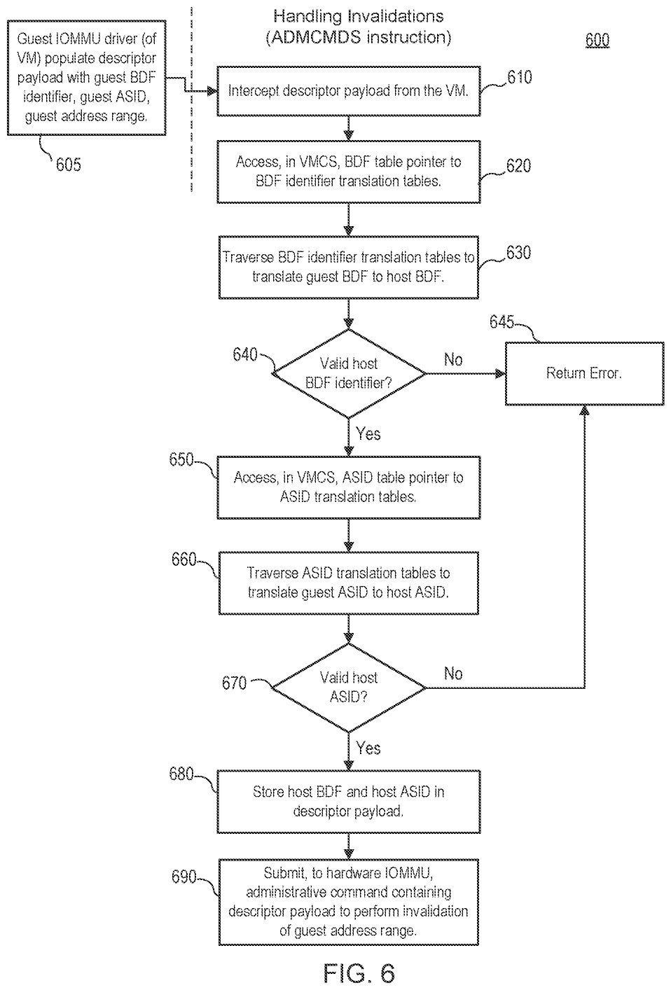

FIG. 6 is a flow chart of a method 600 of handling invalidations from a virtual machine (VM) with virtualization support from the hardware IOMMU 150, according to some implementations. The method 600 may be performed by processing logic that may comprise hardware (e.g., circuitry, dedicated logic, programmable logic, microcode, etc.), software (such as instructions run on a processing device), firmware, or a combination thereof. In one implementation, the core 110 or the processor 102 in FIG. 1 may perform method 600. Although shown in a particular sequence or order, unless otherwise specified, the order of the processes can be modified. Thus, the illustrated embodiments should be understood only as examples, and the illustrated processes can be performed in a different order, and some processes may be performed in parallel. Additionally, one or more processes can be omitted in various embodiments. Thus, not all processes are required in every embodiment. Other process flows are possible.

Referring to FIG. 6, method 600 may begin with the processing logic executing the guest IOMMU driver of the VM to populate a descriptor payload with a guest BDF identifier, guest ASID identifier, and guest address range to be invalidated (605). The guest IOMMU driver may call the ADMCMDS instruction to cause the processing logic to send the descriptor payload to the proper MMIO register and thus towards the correct SWQ of the hardware IOMMU 150. The method 600 may continue with the processing logic intercepting the descriptor payload from the VM (610). The method 600 may continue with the processing logic accessing, within a VMCS for the VM stored in memory, a first pointer (e.g., a BDF table pointer) to a first set of translation tables (e.g., BDF identifier translation tables) (620). The method 600 may continue with the processing logic traversing (e.g., walking) the first set of translation tables to translate the guest BDF identifier to a host BDF identifier (630).

With continued reference to FIG. 6, the method may continue with the processing logic determining whether the host BDF identifier is valid, e.g., exists (640). If the host BDF identifier is not valid, the method 600 may return an error to the system OS, which may be a type of fault (645). If the host BDF identifier is valid, the method 600 may continue with the processing logic accessing, within the VMCS, a second pointer (e.g., ASID table pointer) to a second set of translation tables (e.g., ASID translation tables) (650). The method 600 may continue with the processing logic traversing (e.g., walking) the second set of translation tables to translate the guest ASID to a host ASID (660).

The method 600 may continue with the processing logic determining whether the host ASID translated in block 660 is valid, e.g., exists (670). If the host ASID is not valid, the method 600 may continue with again returning an error or fault (645). If the host ASID is valid, the method 600 may continue with the processing logic inserting the host BDF identifier and the host ASID in the descriptor payload (680). The method 600 may continue with the processing logic submitting, to the hardware IOMMU, an administrative command containing the descriptor payload to perform invalidation of the guest address range (690).

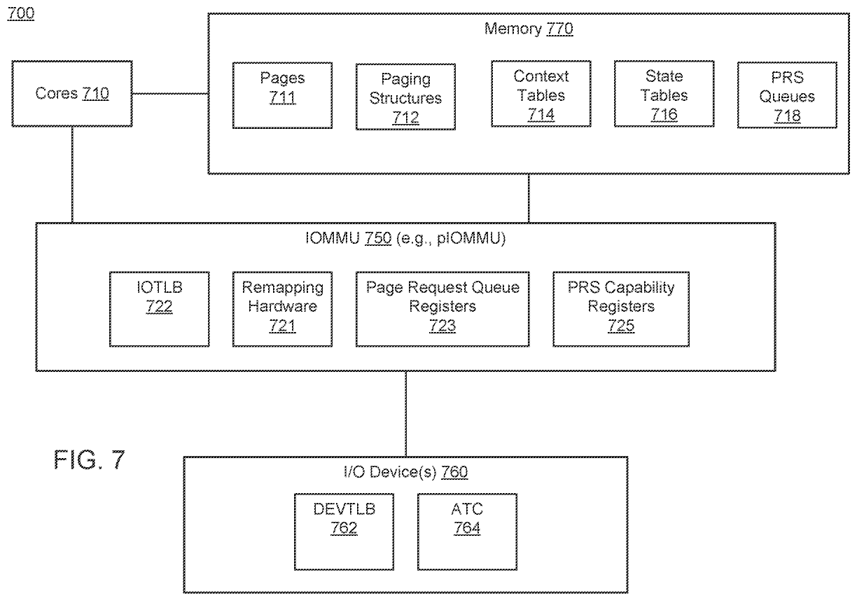

FIG. 7 is a block diagram of a computing system 700 illustrating hardware-based virtualization of IOMMU to handle page requests, according to implementations. The system 700 includes multiple cores 710, a memory 770, a hardware IOMMU 750, and one or more I/O device(s) 760. The components and features of the system 700 of FIG. 7 are consistent and combinable with similar components and features described with reference to the computing system 100 of FIG. 1. Accordingly, additional reference will be made to the computing system 100 of FIG. 1.

The memory 770 may store a number of data structures that are accessible by the hardware IOMMU 750 and by the VM's 140 through 190. These data structures may include, but are not limited to, pages 711 containing data in the memory 770 (which may also be accessed by the I/O devices 760 via direct memory access (DMA)), paging structures 712 for nested translation of the pages 711 between virtual addresses and guest physical address (first level translation) and between guest physical addresses and host physical addresses (second level translation), context tables 714 for storing extended context entries (for page requests without PASID) and context entries (for page requests with PASID), state tables 716, and page request service (PRS) queues 718.

In various implementations, the state tables 716 may queue additional information that may be used by the hardware IOMMU 750 to translate parameters within the page requests from the I/O devices 760 for direct injection into a corresponding VM, as will be discussed in more detail. There may be a PRS queue 718 for each VM to queue page requests coming into each respective VM from an I/O device. The I/O devices that support PRS can send a page request to the hardware IOMMU 350 to resolve the page fault. Such page request services are forwarded from the hardware IOMMU 350 to the virtual IOMMU (vIOMMU) running in the guest.

The hardware IOMMU 750, furthermore, may include an IOTLB 722, remapping hardware 721, page request queue registers 723, and PRS capability registers 725, among other registers to which the below discussion refers. The remapping hardware 721 may be employed to remap page requests that access translation tables populated by a VMM of a virtual machine for purposes of translating addresses of shared virtual memory (SVM) for the I/O devices 760. At least some of the I/O devices 760 may include a device TLB (DEVTLB) 762 and/or an address translation cache (ATC) to cache local copies of (typically) the host physical addresses of DMA addresses of the pages 711 in the memory 770, although in some cases, the guest addresses may also or optionally be cached, as discussed with reference to FIG. 3.

The I/O devices supporting device TLBs can support recoverable address translation faults for translations obtained by the device TLB (by issuing a translation request to the remapping hardware 721, and receiving a translation completion with successful response code). What device accesses can tolerate and recover from device TLB detected faults and what device accesses cannot tolerate Device TLB detected faults is specific to the I/O device. Device-specific software (e.g., driver) is expected to make sure translations with appropriate permissions and privileges are present before initiating I/O device accesses that cannot tolerate faults. The I/O device operations that can recover from such device TLB faults typically involves two steps, e.g., to: 1) report the recoverable fault to host software (e.g., system OS or VMM), and 2) after the recoverable fault is serviced by the host software, the I/O device operation that originally resulted in the recoverable fault is replayed, in a device-specific manner. The reporting of the recoverable fault to the host software may be done in a device-specific manner (e.g., through the device-specific driver), or if the device supports PCI-Express® Page Request Services (PRS) capability, by issuing a page request message to the remapping hardware 721.

Recoverable faults are detected at the device TLB 762 on the endpoint I/O device. The I/O devices 760 supporting PRS capability may report the recoverable faults as page requests to software through the remapping hardware 721. The software may inform the servicing of the page requests by sending page responses to the I/O device through the remapping hardware 721. When PRS capability is enabled at the I/O device, recoverable faults detected at its I/O device TLB may cause the I/O device to issue page request messages to the remapping hardware 721.

The remapping hardware 721 may support a page request queue, as a circular buffer in the memory 770 to record page request messages received, where the PRS queues 718 are a type of page request queue, e.g., associated with PRS capability. In the disclosed implementation, there may be a PRS queue 718 for each VM being executed by the core(s) 710. The page request queue registers 723 may be configured to manage a page request queue, which may be referred to herein as one of the PRS queues 718 for any given VM. The page request queue registers 723, for example, may include the following registers: a page request queue address register (or just “address register”), a page request queue head register (“head register”), and a page request queue tail register (“tail register”).

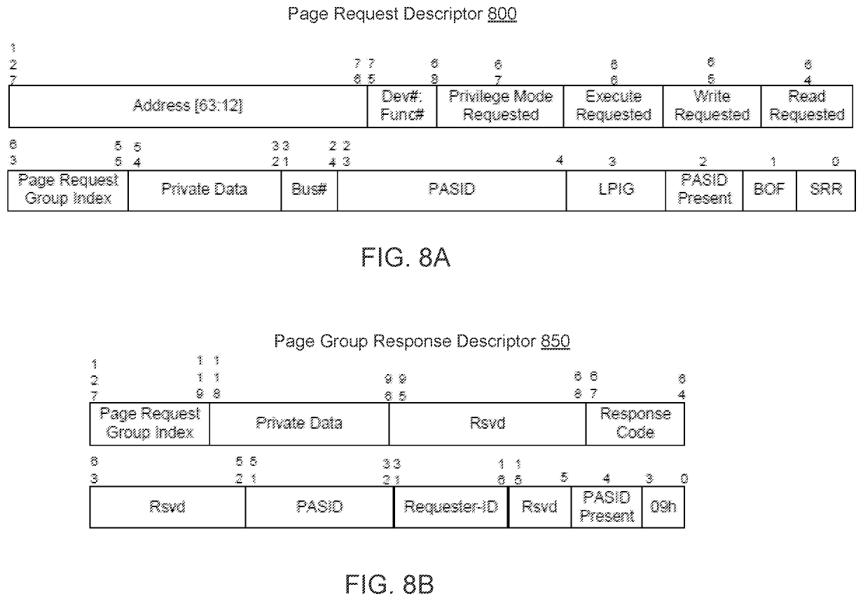

In various implementations, system software (e.g., OS or VMM) may program the page request queue address register to configure the base physical address and size of the contiguous memory region in system memory hosting the page request queue. The page request queue register may point to a page request descriptor in the page request queue that software will process next. One example of a page request descriptor is the page request descriptor 800 illustrated in FIG. 8A. Software such as the VMM may increment the address register after processing one or more page request descriptors in the page request queue. The tail register may point to the page-request descriptor 800 in the page request queue to be written next by the hardware IOMMU 150, e.g., the hardware IOMMU 750. The head register may be incremented by the hardware IOMMU 150 after writing the page request descriptor to the page request queue.

In some implementations, the hardware IOMMU 750 may interpret the page request queue as empty when the head and tail registers are equal. The hardware IOMMU 750 may interpret the page request queue as full when the head register is one behind the tail register (i.e., when all entries but one in the queue are used). In this way, the hardware IOMMU 750 may write at most N−1 page-requests in an N-entry page request queue.

To enable page requests from an I/O device, the VMM may perform the following operations. For example, the VMM may initialize the head and tail registers to zero, configure the extended-context entry used to process requests from the device, such that both the resent (P) and Page Request Enable (PRE) fields are set, setup the page request queue address and size through the address register, configure and enable page requests at the I/O device through the PRS capability registers 725.

A page request message received by the remapping hardware 721 may be discarded if any of the following conditions are true: 1) the Present (P) field or the Page Request Enable (PRE) field in the extended-context entry used to process the page request is zero (“0”), or 2) the page request has value of 0 for both Last Page in Group (LPIG) and Stream Response Requested (SRR) fields (indicates no response is required for this request), and one of the following is true: a) the Page Request Overflow (PRO) field in the fault status register is one (“1”), or b) the Page Request Queue is already full (i.e., the current value of the head register is one behind the value of the rail register), causing hardware to set the Page Request Overflow (PRO) field in the fault status register. Setting the PRO field can cause a fault event to be generated depending on the programming of the fault event registers.

A page request message with the Last Page In Group (LPIG) field clear and the Stream Response Requested (SRR) field set received by the remapping hardware 721 results in hardware returning a successful Page Stream Response message, if one of the following is true: a) the PRO field in the fault status register is 1; or b) the page request queue is already full (i.e., the current value of the head register is one behind the value of the tail register), causing hardware to Set the Page Request Overflow (PRO) field in the fault Status Register. Setting the PRO field can cause a fault event to be generated depending on the programming of the fault event registers.

A page request message with the LPIG field set received by the remapping hardware 721 results in hardware returning a successful Page Group Response message, if one of the following is true: a) the Page Request Overflow (PRO) field in the fault status register is one (“1”), or b) the page request queue is already full (i.e., the current value of the head register is one behind the value of the tail register), causing the hardware IOMMU 750 to set the PRO field in the fault status register. Setting the PRO field can cause a fault event to be generated depending on the programming of the fault event registers. If none of above conditions are true on receiving a page request message, the remapping hardware 721 may performs an implicit invalidation to invalidate any translations cached in the IOTLB 722 and paging structure caches that controls the address specified in the Page Request. The remapping hardware 721 may further writes a page request descriptor to the page request queue entry at offset specified by the head register, and increments the value in the head register. Depending on the type of the page request descriptor written to the page request queue and programming of the page request event registers, a recoverable fault event may be generated.

The implicit invalidation of IOTLB and paging structure caches by the remapping hardware 721 before a page request may be reported to system software, along with the I/O device requirement to invalidate faulting translation from its device TLB before sending the page request, enforces there are no cached translations for a faulted page address before the page request is reported to software. This allows software to service a recoverable fault by making necessary modifications to the paging entries and send a page response to restart the faulted operation at the device, without performing any explicit invalidation operations.

FIG. 8A is a block diagram illustrating a page request descriptor 800, according to one implementation, which may be written by the hardware IOMMU 750. The page request descriptor 800 may also be presented to the IOMMU driver of a VM to inject the page request into the guest OS of the VM. The page request descriptor 800 may be 128-bit sized. The Type field (bits 1:0) of each page request descriptor may identify the descriptor type. The page request descriptor 800 may be used to report page request messages received by the remapping hardware 721.

Page Request Messages: Page request messages are sent by the I/O devices 760 to report one or more page requests that are part of a page group (i.e., with same value in Page Request Group Index field), for which a page group response is expected by the device after software has serviced the requests that are part of the page group. A page group can be composed of as small as a single page request. Page requests with PASID Present field value of one (“1”) are considered as page-requests-with-PASID. Page requests with PASID Present field value of zero (“0”) are considered as page-requests-without-PASID. For Root-Complex integrated devices, any page-request-with-PASID in a page group, except the last page request (i.e., requests with Last Page in Group (LPIG) field value of 0), can request a page stream response when that individual page request is serviced, by setting the Streaming Response Requested (SRR) field. Intel® Processor Graphics device may require use of this page stream response capability.

The Page Request Descriptor 800 (page_req_dsc) may include the following fields, which is a non-exhaustive list.

Bus Number: The bus number field contains the upper 8-bits of the source-id of the endpoint device that sent the page request.

Device and Function Numbers: The Dev#:Func# field contains the lower 8-bits of the source-id of the endpoint device that sent the page request.

PASID Present: If the PASID Present field is 1, the page request is due to a recoverable fault by a request-with-PASID. If PASID Present field is 0, the page request is due to a recoverable fault by a request-without-PASID.

PASID: If the PASID Present field is 1, this field provides the PASID value of the request-with-PASID that encountered the recoverable fault that resulted in this page request. If PASID Present field is 0, this field is undefined.

Address (ADDR): If both the Read Requested and Write Requested fields are 0, this field is reserved. Else, this field indicates the faulted page address. If the PASID Present field is 1, the address field specifies an input-address for first-level translation. If the PASID Present field is 0, the address field specifies an input-address for second-level translation.

Page Request Group Index (PRGI): The 9-bit Page Request Group Index field identifies the page group to which this request is part of. Software is expected to return the Page Request Group Index in the respective page response. This field is undefined if both the Read Requested and Write Requested fields are 0. Multiple page-requests-with-PASID (PASID Present field value of 1) from a device with same PASID value can contain any Page Request Group Index value (0-511). However, for a given PASID value, there can at most be one page-request-with-PASID outstanding from a device, with Last Page in Group (LPIG) field Set and same Page Request Group Index value. Multiple page-requests-without-PASID (PASID Present field value of 0) from a device can contain any Page Request Group Index value (0-511). However, there can at most be one page-request-without-PASID outstanding from a device, with Last Page in Group field Set and same Page Request Group Index value.

Last Page in Group (LPIG): If the Last Page in Group field is 1, this is the last request in the page group identified by the value in the Page Request Group Index field.

Streaming Response Requested (SRR): If the Last Page in Group (LPIG) field is 0, a value of 1 in the Streaming Response Requested (SRR) field indicates a Page Stream Response is requested for this individual page request after it is serviced. If Last Page in Group (LPIG) field is 1, this field is reserved (0).

Blocked on Fault (BOF): If the Last Page in Group (LPIG) field is 0 and Streaming Response Requested (SRR) field is 1, a value of 1 in the Blocked on Fault (BOF) field indicates the fault that resulted in this page request resulted in a blocking condition on the Root-Complex integrated endpoint device. This field is informational and may be used by software to prioritize processing of such blocking page requests over normal (non-blocking) page requests for improved endpoint device performance or quality of service. If Last Page in Group (LPIG) field is 1 or Streaming Response Requested (SRR) field is 0, this field is reserved (0).

Read Requested: If the Read Requested field is 1, the request that encountered the recoverable fault (that resulted in this page request), requires read access to the page.

Write Requested: If the Write Requested field is 1, the request that encountered the recoverable fault (that resulted in this page request), requires write access to the page.

Execute Requested: If the PASID Present, Read Requested and Execute Requested fields are all 1, the request-with-PASID that encountered the recoverable fault that resulted in this page request, requires execute access to the page.

Privilege Mode Requested: If the PASID Present is 1, and at least one of the Read Requested or the Write Requested field is 1, the Privilege Mode Requested field indicates the privilege of the request-with-PASID that encountered the recoverable fault (that resulted in this page request). A value of 1 for this field indicates supervisor privilege, and value of 0 indicates user privilege.

Private Data: The Private Data field can be used by Root-Complex integrated endpoints (e.g., I/O devices) to uniquely identify device-specific private information associated with an individual page request. For an Intel® Processor Graphics device, the Private Data field specifies the identity of the GPU advanced-context sending the page request. For page requests requesting a page stream response (SRR=1 and LPIG=0), software is expected to return the Private Data in the respective Page Stream Response. For page requests that identifies as the last request in a page group (LPIG=1), software is expected to return the Private Data in the respective Page Group Response.

For page-requests-with-PASID indicating page stream response (SRR=1 and LPIG=0), software responds with a Page Stream response after the respective page request is serviced. For page requests indicating last request in group (LPIG=1), software responds with a Page Group Response after servicing page requests that are part of that page group.

FIG. 8B is a block diagram illustrating a page group response descriptor 850, according to one implementation. A page group response descriptor 850 may be issued by software (e.g., VM) in response to a page request indicating last request in a group. The page group response is issued after servicing page requests with the same page request group index value. The Page Group Request Descriptor 850 (page_grp_resp_dsc) includes the following fields, which is a non-exhaustive list:

Requester-ID: The Requester-ID field identifies the endpoint I/O device function targeted by the Page Request Group Response. The upper 8-bits of the Requester-ID field specifies the bus number and the lower 8-bits specifies the device number and function number. Software copies the bus number, device number, and function number fields from the respective page request descriptor 800 to form the Requester-ID field in the Page Group Response Descriptor.

PASID Present: If the PASID Present field is 1, the Page Group Response carries a PASID. The value in this field should match the value in the PASID Present field of the respective page request descriptor 800.

PASID: If the PASID Present field is 1, this field provides the PASID value for the Page Group Response. The value in this field should match the value in the PASID field of the respective page request descriptor 800.

Page Request Group Index: The Page Request Group Index identifies the page group of this Page Group Response. The value in this field should match the value in the Page Request Group Index field of the respective Page Request Descriptor.

Response Code: The Response Code indicates the Page Group Response status. The field follows the Response Code (see Table 1) in Page Group Response message as specified in the PCI Express® Address Translation Services (ATS) specification. If page requests that are part of a Page Group are serviced successfully, Response Status code of Success is returned.

TABLE 1

| Value | Status | Description |
|---|---|---|
| 0 h | Success | All Page Requests in the Page Request Group were |
| | | successfully serviced. |
| 1 h | Invalid | One [symbol] more Page Requests within the Page Request |
| | Request | Group was not successfully serviced. |
| 2 h- [symbol] | Reserved | Not used. |
| [symbol] | Response | Servicing of one or more Page Requests within the |
| | Failure | Page Request Group encountered a non-recoverable |
| | | error. |

[symbol]

indicates data missing or illegible when filed

Private Data: The Private Data field is used to convey device-specific private information associated with the page request and response. The value in this field should match the value in the Private Data field of the respective page request descriptor 800.

With additional reference to FIGS. 1, 7, and 8A-8B, the present implementations are to configure the hardware IOMMU 750 to inject page requests directly into the VMs 140 through 190 without any VMM overhead. Avoiding the software overhead of VMM functionality will greatly increase efficiency and bandwidth of page request handling between the I/O devices 760 and the VMs. To do so, the hardware IOMMU 750 may perform a reverse address translation to look up the host physical BDF and a host PASID and to translate these respectively to a guest BDF and guest virtual PASID. To support this additional functionality, the relevant information performing the reverse translations may be stored in the extended-context entry (for page request without PASID) and in the context entry for page requests with PASID. Recall that the extended-context entries and context entries are stored in the context tables 714 in memory 770.

Further note that when a conventional hardware IOMMU generates a page fault, the conventional hardware IOMMU does not distinguish whether the page fault is generated in a first level page tables or a second level page table. Accordingly, the hardware IOMMU 750 may be enhanced to identify which level page tables resulted in or cause the page fault. The hardware IOMMU 750 may also be enhanced to support multiple the PRS queues 718, one for each VM. These PRS queues 718 may be mapped and directly accessible from the respective VMs.

In various implementations, the extended-context entries and the context entries of the hardware IOMMU 750 may be modified to include at least the following information: 1) a guest BDF to be included in the guest page request; 2) a guest PASID to be included in the guest page request; 3) an interrupt handle to generate a posted interrupt to the guest VM that owns the I/O device; and 4) a PRS queue pointer where the received page request (PRS) will be queued for handling. In the event the extended-context entries and/or the context entries do not have enough spare room to store this additional information, the PASID state table pointer may instead point to an new entry (e.g., in the state tables 716) that stores the above four pieces of information. The hardware IOMMU 750 may then use this additional information within the context entries or may follow the PASID state table pointer to the new entry in the state tables 716 to retrieve the additional information.

In implementations, when the hardware IOMMU 750 receive an page request from an I/O device, the hardware IOMMU 750 may determine whether the page fault occurred in a first level or a second level of the nested pages tables (stored in the paging structures 712). If the page fault occurred in a first-level page table, the page fault is to be processed by the VM, which is to receive the page request. And, if the page fault occurred in the second-level page table, the page fault is to be processed by the VMM or host OS, which is to receive the page request. The hardware IOMMU 750 may then identify the guest BDF, the guest PASID, the PRS queue, and the PRS interrupt from the extended context entry (for page requests without PASID) or from the context entry (for page requests with PASID). The hardware IOMMU 750 may place the translated PRS page request with appropriate guest BDF and guest PASID in the corresponding PRS queue before posting an interrupt to the guest VM.

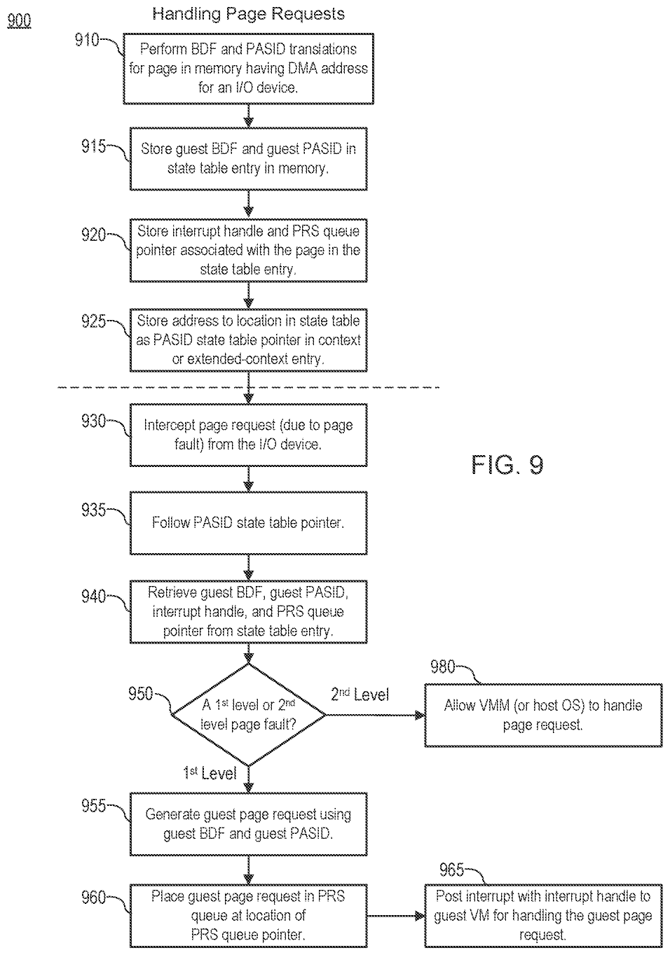

FIG. 9 is a flow chart of a method 900 of handling page requests from I/O devices with virtualization support from a hardware IOMMU, according to some implementations. The method 900 may be performed by processing logic that may comprise hardware (e.g., circuitry, dedicated logic, programmable logic, microcode, etc.), software (such as instructions run on a processing device), firmware, or a combination thereof. In one implementation, the computing device 100 (FIG. 1) or 700 (FIG. 7) may perform the method 900. More particularly, the hardware IOMMU 150 (FIG. 1) or 750 (FIG. 7) may perform the method 900. Although shown in a particular sequence or order, unless otherwise specified, the order of the processes can be modified. Thus, the illustrated embodiments should be understood only as examples, and the illustrated processes can be performed in a different order, and some processes may be performed in parallel. Additionally, one or more processes can be omitted in various embodiments. Thus, not all processes are required in every embodiment. Other process flows are possible.

With reference to FIG. 9, the method 900 may begin with processing logic (e.g., the processor 102) performing translations of a host BDF to a guest BDF and a host PASID to a guest PASID for a page in memory having a DMA address associated with an I/O device (910). Once these translations are complete, the method 900 may continue with the processing logic (e.g., of a hardware IOMMU) storing the guest BDF and the guest PASID in a state table entry in memory (915). The method 900 may continue with the processing logic storing an interrupt handle and PRS queue pointer associated with the page in the state table entry (920). The method 900 may continue with the processing logic storing the address to a location in the state table as the PASID state table pointer in the context entry and the extended context entry associated with the page in memory (925).

After the passage of time, with continued reference to FIG. 9, the method 900 may continue with the processing logic intercepting a page request (due to a page fault) from the I/O device (930). In one implementation, the page request comes in the form of the page request descriptor 800 discussed with reference to FIG. 8A. The method 900 may continue with the processing logic following the PASID state table pointer (previously stored in the context entry and the extended context entry) to the location in the state table (935). The method 900 may continue with the processing logic retrieving the guest BDF, the guest PASID, the interrupt handle, and the PRS queue pointer from the state table entry (940). The method 900 may continue with the processing logic determining whether the page fault is a first-level or a second-level page fault (950). If the page fault is a first-level page fault (e.g., occurred in a first-level page table), the method 900 may continue with the processing logic generating a guest page request using the guest BDF and the guest PASID (e.g., inserted into the page request descriptor 800) (955). The method 900 may continue with the processing logic placing the guest page request in the PRS queue at the location of the PRS queue pointer (960). The method 900 may continue with the processing logic posting, using the interrupt handle, an interrupt to the guest VM for handling the guest page request (965). If, however, the page fault is a second-level page fault (e.g., occurred in a second-level page table), the method 900 may continue with the processing logic allowing the VMM or host OS to handle the page request (980). The process of method 900 may be reversed to send a page response back to the I/O device.

With further reference to FIGS. 6-7, 8A-8B, and 9, page response are to be sent back to the I/O device with the original (host) PASID that came along with the page request. For page requests that are submitted using the ENQCMD instruction, the page request may arrive with a host PASID. But, sending the page request to the guest VM is to be sent with a guest PASID. For direct-assigned dedicated queues (FIG. 3), the guest software (e.g., OS in the VM) may have programmed the guest PASID directly in the I/O device. Accordingly, those page requests may arrive with the guest PASID already. Consequently, page requests may arrive at the hardware IOMMU 750 with either the guest PASID or host PASID, and the hardware IOMMU is to appropriately translate the host PASID to the guest PASID before injecting the page request to the VM.

In various implementations, the PASID in the page request may include either the host PASID due to a command submitted to the I/O device via an ENQCMD instruction, or the guest PASID in the case this is a PCIe® I/O single-root virtualization (SR-IOV) device, and the guest IOMMU driver directly programmed the PASID into its device context entry. In view of these two possibilities, the hardware IOMMU 750 may first find the guest PASID to pass to the VM in a guest page request. In order to assist with this lookup, the PASID context entry may also contain the assigned guest PASID, as previously discussed. Similarly, for the corresponding guest PASID entry (in the PASID table) may also have the same guest PASID. This process may complete the task of locating the guest PASID for the incoming host PASID as part of processing a page request. The hardware IOMMU 750 may then substitute in the guest PASID if the incoming PASID for the page request was a host PASID.

In implementations, in order to help with preserving the original (host) PASID of the page request, the hardware IOMMU may save the PASID in an internal data structure either on the I/O device or in system memory as assigned by the IOMMU driver of the VM (e.g., in context entries, extended context entries, or state tables). The IOMMU may then place the hash lookup of such an assignment in the private data field of the page request descriptor 800. In this way, the hardware IOMMU 750 may have access to both the guest PASID and the host PASID for use in generating a page response. That is, when processing page responses, the private data is expected to be replicated. The guest IOMMU driver may simply copy the private data into the page response descriptor 850 when posting the page response descriptor using the ADMCMDS instruction discussed previously. The hardware IOMMU 750 may then lookup the data and replace the guest PASID with the host PASID, which may go into the page response. The page response may then be transmitted by to the I/O that originally issued the page request.

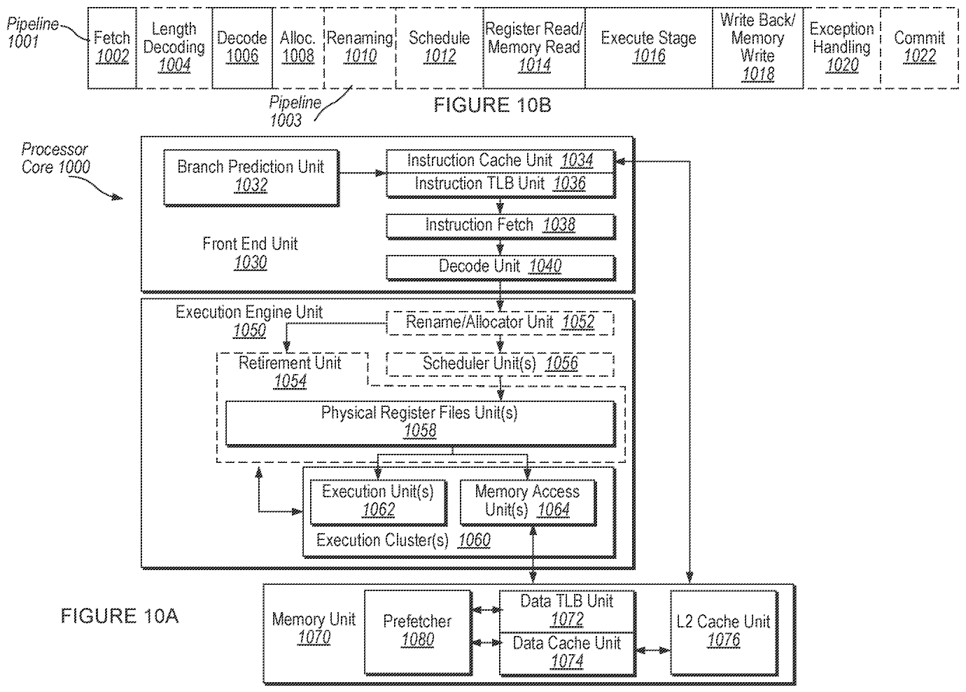

FIG. 10A is a block diagram illustrating a micro-architecture for a processor 1000 that may implement hardware-based virtualization of an IOMMU, according to an implementation. Specifically, processor 1000 depicts an in-order architecture core and a register renaming logic, out-of-order issue/execution logic to be included in a processor according to at least one implementation of the disclosure.

Processor 1000 includes a front end unit 1030 coupled to an execution engine unit 1050, and both are coupled to a memory unit 1070. The processor 1000 may include a reduced instruction set computing (RISC) core, a complex instruction set computing (CISC) core, a very long instruction word (VLIW) core, or a hybrid or alternative core type. As yet another option, processor 1000 may include a special-purpose core, such as, for example, a network or communication core, compression engine, graphics core, or the like. In one implementation, processor 1000 may be a multi-core processor or may be part of a multi-processor system.

The front end unit 1030 includes a branch prediction unit 1032 coupled to an instruction cache unit 1034, which is coupled to an instruction translation lookaside buffer (TLB) 1036, which is coupled to an instruction fetch unit 1038, which is coupled to a decode unit 1040. The decode unit 1040 (also known as a decoder) may decode instructions, and generate as an output one or more micro-operations, micro-code entry points, microinstructions, other instructions, or other control signals, which are decoded from, or which otherwise reflect, or are derived from, the original instructions. The decoder 1040 may be implemented using various different mechanisms. Examples of suitable mechanisms include, but are not limited to, look-up tables, hardware implementations, programmable logic arrays (PLAs), microcode read only memories (ROMs), etc. The instruction cache unit 1034 is further coupled to the memory unit 1070. The decode unit 1040 is coupled to a rename/allocator unit 1052 in the execution engine unit 1050.

The execution engine unit 1050 includes the rename/allocator unit 1052 coupled to a retirement unit 1054 and a set of one or more scheduler unit(s) 1056. The scheduler unit(s) 1056 represents any number of different scheduler circuits, including reservations stations (RS), central instruction window, etc. The scheduler unit(s) 1056 is coupled to the physical register set(s) unit(s) 1058. Each of the physical register set(s) units 1058 represents one or more physical register sets, different ones of which store one or more different data types, such as scalar integer, scalar floating point, packed integer, packed floating point, vector integer, vector floating point, etc., status (e.g., an instruction pointer that is the address of the next instruction to be executed), etc. The physical register set(s) unit(s) 1058 is overlapped by the retirement unit 1054 to illustrate various ways in which register renaming and out-of-order execution may be implemented (e.g., using a reorder buffer(s) and a retirement register set(s), using a future file(s), a history buffer(s), and a retirement register set(s); using a register maps and a pool of registers; etc.).

Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 1054 and the physical register set(s) unit(s) 1058 are coupled to the execution cluster(s) 1060. The execution cluster(s) 1060 includes a set of one or more execution units 1062 and a set of one or more memory access units 1064. The execution units 1062 may perform various operations (e.g., shifts, addition, subtraction, multiplication) and operate on various types of data (e.g., scalar floating point, packed integer, packed floating point, vector integer, vector floating point).

While some implementations may include a number of execution units dedicated to specific functions or sets of functions, other implementations may include only one execution unit or multiple execution units that all perform all functions. The scheduler unit(s) 1056, physical register set(s) unit(s) 1058, and execution cluster(s) 1060 are shown as being possibly plural because certain implementations create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register set(s) unit, and/or execution cluster—and in the case of a separate memory access pipeline, certain implementations are implemented in which only the execution cluster of this pipeline has the memory access unit(s) 1064). It should also be understood that where separate pipelines are used, one or more of these pipelines may be out-of-order issue/execution and the rest in-order.

The set of memory access units 1064 is coupled to the memory unit 1070, which may include a data prefetcher 1080, a data TLB unit 1072, a data cache unit (DCU) 1074, and a level 2 (L2) cache unit 1076, to name a few examples. In some implementations DCU 1074 is also known as a first level data cache (L1 cache). The DCU 1074 may handle multiple outstanding cache misses and continue to service incoming stores and loads. It also supports maintaining cache coherency. The data TLB unit 1072 is a cache used to improve virtual address translation speed by mapping virtual and physical address spaces. In one exemplary implementation, the memory access units 1064 may include a load unit, a store address unit, and a store data unit, each of which is coupled to the data TLB unit 1072 in the memory unit 1070. The L2 cache unit 1076 may be coupled to one or more other levels of cache and eventually to a main memory.

In one implementation, the data prefetcher 1080 speculatively loads/prefetches data to the DCU 1074 by automatically predicting which data a program is about to consume. Prefetching may refer to transferring data stored in one memory location (e.g., position) of a memory hierarchy (e.g., lower level caches or memory) to a higher-level memory location that is closer (e.g., yields lower access latency) to the processor before the data is actually demanded by the processor. More specifically, prefetching may refer to the early retrieval of data from one of the lower level caches/memory to a data cache and/or prefetch buffer before the processor issues a demand for the specific data being returned.

The processor 1000 may support one or more instructions sets (e.g., the x86 instruction set (with some extensions that have been added with newer versions); the MIPS instruction set of Imagination Technologies of Kings Langley, Hertfordshire, UK; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated implementation of the processor also includes a separate instruction and data cache units and a shared L2 cache unit, alternative implementations may have a single internal cache for both instructions and data, such as, for example, a Level 1 (L1) internal cache, or multiple levels of internal cache. In some implementations, the system may include a combination of an internal cache and an external cache that is external to the core and/or the processor. Alternatively, all of the cache may be external to the core and/or the processor.

FIG. 10B is a block diagram illustrating an in-order pipeline and a register renaming stage, out-of-order issue/execution pipeline that may implement hardware-based virtualization of an IOMMU as per processor 1000 of FIG. 10A according to some implementations of the disclosure. The solid lined boxes in FIG. 10B illustrate an in-order pipeline 1001, while the dashed lined boxes illustrate a register renaming, out-of-order issue/execution pipeline 1003. In FIG. 10B, the pipelines 1001 and 1003 include a fetch stage 1002, a length decode stage 1004, a decode stage 1006, an allocation stage 1008, a renaming stage 1010, a scheduling (also known as a dispatch or issue) stage 1012, a register read/memory read stage 1014, an execute stage 1016, a write back/memory write stage 1018, an exception handling stage 1022, and a commit stage 1024. In some implementations, the ordering of stages 1002-1024 may be different than illustrated and are not limited to the specific ordering shown in FIG. 10B.

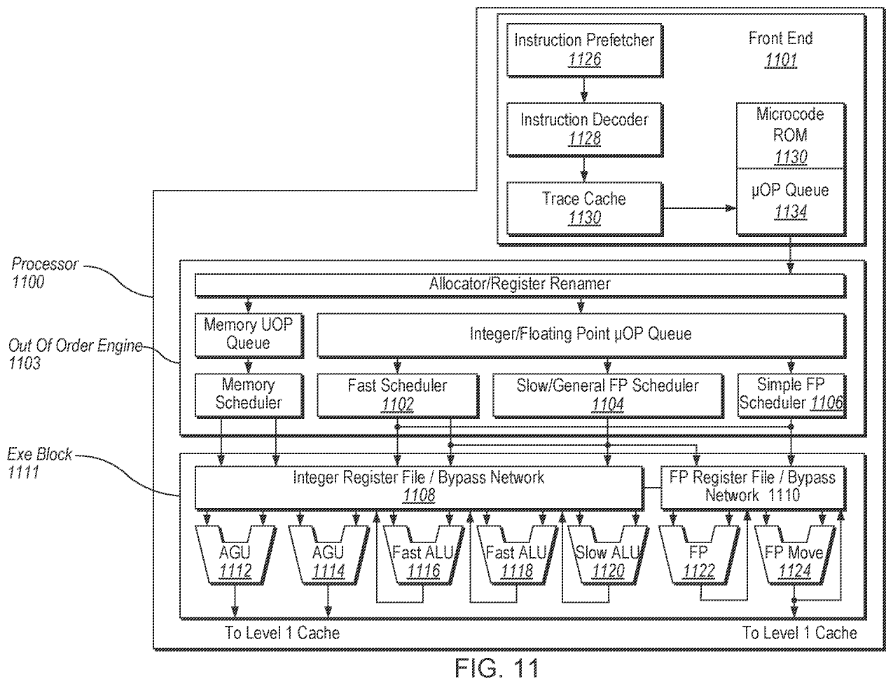

FIG. 11 illustrates a block diagram of the micro-architecture for a processor 1100 that includes logic circuits of a processor or an integrated circuit that may implement hardware-based virtualization of an IOMMU, according to an implementation of the disclosure. In some implementations, an instruction in accordance with one implementation can be implemented to operate on data elements having sizes of byte, word, doubleword, quadword, etc., as well as datatypes, such as single and double precision integer and floating point datatypes. In one implementation the in-order front end 1101 is the part of the processor 1100 that fetches instructions to be executed and prepares them to be used later in the processor pipeline. The implementations of the page additions and content copying can be implemented in processor 1100.

The front end 1101 may include several units. In one implementation, the instruction prefetcher 1116 fetches instructions from memory and feeds them to an instruction decoder 1118 which in turn decodes or interprets them. For example, in one implementation, the decoder decodes a received instruction into one or more operations called “micro-instructions” or “micro-operations” (also called micro op or uops) that the machine can execute. In other implementations, the decoder parses the instruction into an opcode and corresponding data and control fields that are used by the micro-architecture to perform operations in accordance with one implementation. In one implementation, the trace cache 1130 takes decoded uops and assembles them into program ordered sequences or traces in the uop queue 1134 for execution. When the trace cache 1130 encounters a complex instruction, microcode ROM (or RAM) 1132 provides the uops needed to complete the operation.

Some instructions are converted into a single micro-op, whereas others need several micro-ops to complete the full operation. In one implementation, if more than four micro-ops are needed to complete an instruction, the decoder 1118 accesses the microcode ROM 1132 to do the instruction. For one implementation, an instruction can be decoded into a small number of micro ops for processing at the instruction decoder 1118. In another implementation, an instruction can be stored within the microcode ROM 1132 should a number of micro-ops be needed to accomplish the operation. The trace cache 1130 refers to an entry point programmable logic array (PLA) to determine a correct micro-instruction pointer for reading the micro-code sequences to complete one or more instructions in accordance with one implementation from the micro-code ROM 1132. After the microcode ROM 1132 finishes sequencing micro-ops for an instruction, the front end 1101 of the machine resumes fetching micro-ops from the trace cache 1130.

The out-of-order execution engine 1103 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register set. The allocator also allocates an entry for each uop in one of the two uop queues, one for memory operations and one for non-memory operations, in front of the instruction schedulers: memory scheduler, fast scheduler 1102, slow/general floating point scheduler 1104, and simple floating point scheduler 1106. The uop schedulers 1102, 1104, 1106, determine when a uop is ready to execute based on the readiness of their dependent input register operand sources and the availability of the execution resources the uops need to complete their operation. The fast scheduler 1102 of one implementation can schedule on each half of the main clock cycle while the other schedulers can only schedule once per main processor clock cycle. The schedulers arbitrate for the dispatch ports to schedule uops for execution.

Register sets 1108, 1110, sit between the schedulers 1102, 1104, 1106, and the execution units 1112, 1114, 1116, 1118, 1120, 1122, 1124 in the execution block 1111. There is a separate register set 1108, 1110, for integer and floating point operations, respectively. Each register set 1108, 1110, of one implementation also includes a bypass network that can bypass or forward just completed results that have not yet been written into the register set to new dependent uops. The integer register set 1108 and the floating point register set 1110 are also capable of communicating data with the other. For one implementation, the integer register set 1108 is split into two separate register sets, one register set for the low order 32 bits of data and a second register set for the high order 32 bits of data. The floating point register set 1110 of one implementation has 128 bit wide entries because floating point instructions typically have operands from 64 to 128 bits in width.

The execution block 1111 contains the execution units 1112, 1114, 1116, 1118, 1120, 1122, 1124, where the instructions are actually executed. This section includes the register sets 1108, 1110, that store the integer and floating point data operand values that the micro-instructions need to execute. The processor 1100 of one implementation is comprised of a number of execution units: address generation unit (AGU) 1112, AGU 1114, fast ALU 1116, fast ALU 1118, slow ALU 1120, floating point ALU 1112, floating point move unit 1114. For one implementation, the floating point execution blocks 1112, 1114, execute floating point, MMX, SIMD, and SSE, or other operations. The floating point ALU 1112 of one implementation includes a 64 bit by 64 bit floating point divider to execute divide, square root, and remainder micro-ops. For implementations of the disclosure, instructions involving a floating point value may be handled with the floating point hardware.

In one implementation, the ALU operations go to the high-speed ALU execution units 1116, 1118. The fast ALUs 1116, 1118, of one implementation can execute fast operations with an effective latency of half a clock cycle. For one implementation, most complex integer operations go to the slow ALU 1120 as the slow ALU 1120 includes integer execution hardware for long latency type of operations, such as a multiplier, shifts, flag logic, and branch processing. Memory load/store operations are executed by the AGUs 1122, 1124. For one implementation, the integer ALUs 1116, 1118, 1120, are described in the context of performing integer operations on 64 bit data operands. In alternative implementations, the ALUs 1116, 1118, 1120, can be implemented to support a variety of data bits including 16, 32, 128, 256, etc. Similarly, the floating point units 1122, 1124, can be implemented to support a range of operands having bits of various widths. For one implementation, the floating point units 1122, 1124, can operate on 128 bits wide packed data operands in conjunction with SIMD and multimedia instructions.

In one implementation, the uops schedulers 1102, 1104, 1106, dispatch dependent operations before the parent load has finished executing. As uops are speculatively scheduled and executed in processor 1100, the processor 1100 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one implementation of a processor are also designed to catch instruction sequences for text string comparison operations.

The term “registers” may refer to the on-board processor storage locations that are used as part of instructions to identify operands. In other words, registers may be those that are usable from the outside of the processor (from a programmer's perspective). However, the registers of an implementation should not be limited in meaning to a particular type of circuit. Rather, a register of an implementation is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one implementation, integer registers store 32-bit integer data. A register set of one implementation also contains eight multimedia SIMD registers for packed data.

For the discussions herein, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one implementation, in storing packed data and integer data, the registers do not need to differentiate between the two data types. In one implementation, integer and floating point are either contained in the same register set or different register sets. Furthermore, in one implementation, floating point and integer data may be stored in different registers or the same registers.

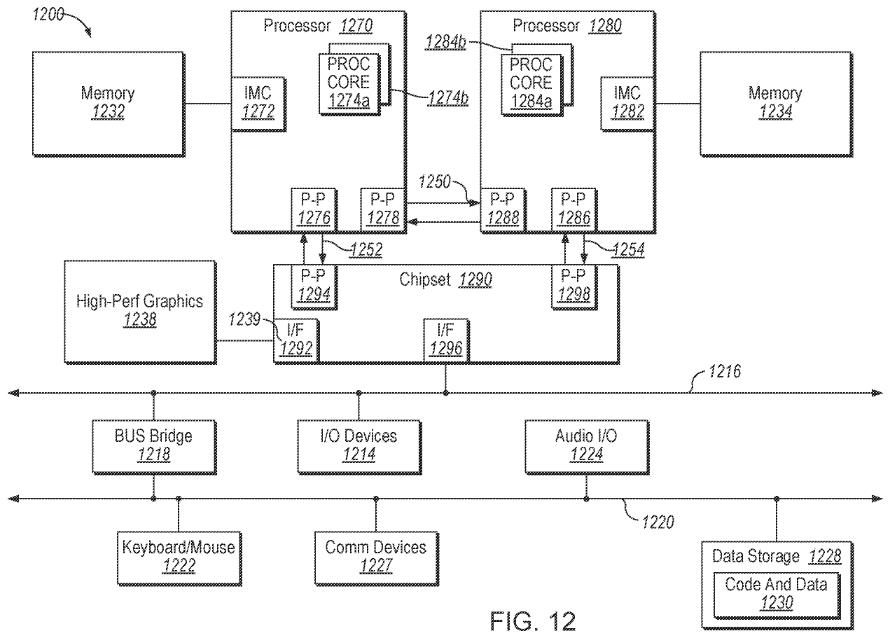

Implementations may be implemented in many different system types. Referring now to FIG. 12, shown is a block diagram of a multiprocessor system 1200 that may implement hardware-based virtualization of an IOMMU, in accordance with an implementation. As shown in FIG. 12, multiprocessor system 1200 is a point-to-point interconnect system, and includes a first processor 1270 and a second processor 1280 coupled via a point-to-point interconnect 1250. As shown in FIG. 12, each of processors 1270 and 1280 may be multicore processors, including first and second processor cores (i.e., processor cores 1274a and 1274b and processor cores 1284a and 1284b), although potentially many more cores may be present in the processors. While shown with two processors 1270, 1280, it is to be understood that the scope of the disclosure is not so limited. In other implementations, one or more additional processors may be present in a given processor.

Processors 1270 and 1280 are shown including integrated memory controller units 1272 and 1282, respectively. Processor 1270 also includes as part of its bus controller units point-to-point (P-P) interfaces 1276 and 1288; similarly, second processor 1280 includes P-P interfaces 1286 and 1288. Processors 1270, 1280 may exchange information via a point-to-point (P-P) interface 1250 using P-P interface circuits 1278, 1288. As shown in FIG. 12, IMCs 1272 and 1282 couple the processors to respective memories, namely a memory 1232 and a memory 1234, which may be portions of main memory locally attached to the respective processors.

Processors 1270, 1280 may exchange information with a chipset 1290 via individual P-P interfaces 1252, 1254 using point to point interface circuits 1276, 1294, 1286, 1298. Chipset 1290 may also exchange information with a high-performance graphics circuit 1238 via a high-performance graphics interface 1239.

Chipset 1290 may be coupled to a first bus 1216 via an interface 1296. In one implementation, first bus 1216 may be a Peripheral Component Interconnect (PCI) bus, or a bus such as a PCI Express bus or interconnect bus, although the scope of the disclosure is not so limited.

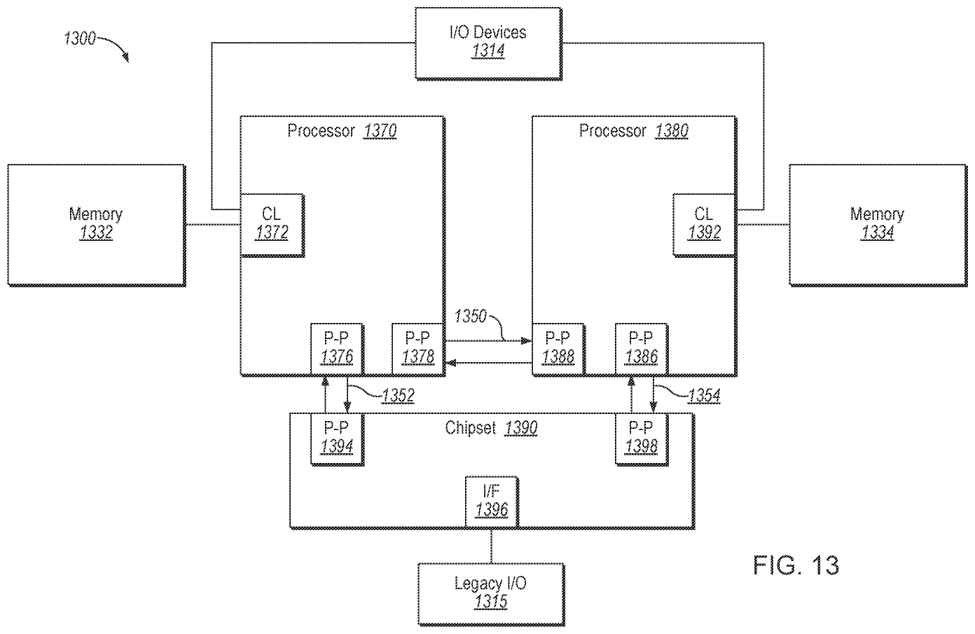

Referring now to FIG. 13, shown is a block diagram of a third system 1300 that may implement hardware-based virtualization of an IOMMU, in accordance with an implementation of the disclosure. Like elements in FIGS. 12 and 13 bear like reference numerals and certain aspects of FIG. 13 have been omitted from FIG. 12 in order to avoid obscuring other aspects of FIG. 13.

FIG. 13 illustrates that the processors 1370, 1380 may include integrated memory and I/O control logic (“CL”) 1372 and 1392, respectively. For at least one implementation, the CL 1372, 1382 may include integrated memory controller units such as described herein. In addition. CL 1372, 1392 may also include I/O control logic. FIG. 13 illustrates that the memories 1332, 1334 are coupled to the CL 1372, 1392, and that I/O devices 1314 are also coupled to the control logic 1372, 1392. Legacy I/O devices 1315 are coupled to the chipset 1390.

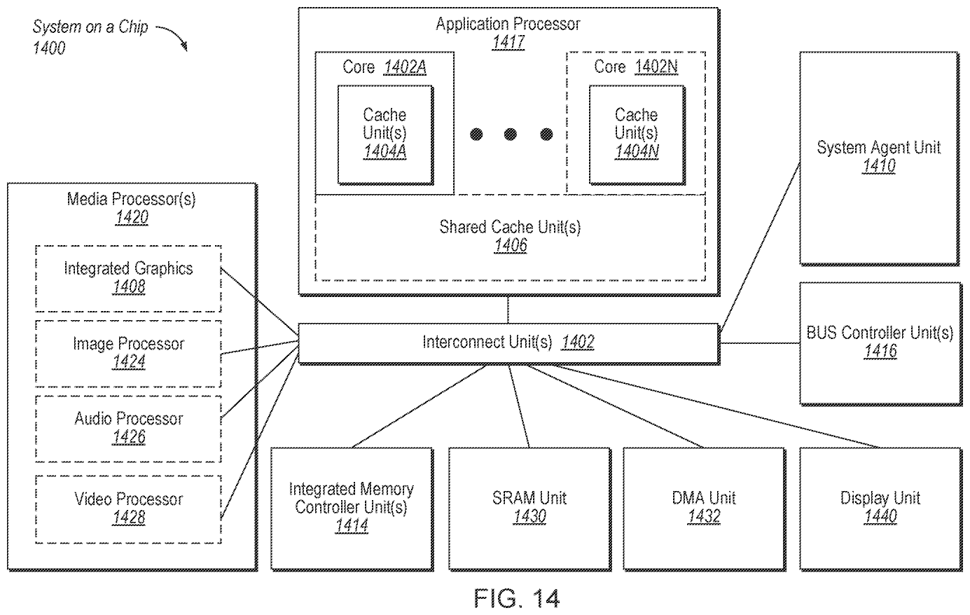

FIG. 14 is an exemplary system on a chip (SoC) 1400 that may include one or more of the cores 1402A . . . 1402N that may implement hardware-based virtualization of an IOMMU. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Within the exemplary SoC 1400 of FIG. 14, dashed lined boxes are features on more advanced SoCs. An interconnect unit(s) 1402 may be coupled to: an application processor 1417 which includes a set of one or more cores 1402A-N and shared cache unit(s) 1406; a system agent unit 1410; a bus controller unit(s) 1416; an integrated memory controller unit(s) 1414; a set of one or more media processors 1420 which may include integrated graphics logic 1408, an image processor 1424 for providing still and/or video camera functionality, an audio processor 1426 for providing hardware audio acceleration, and a video processor 1428 for providing video encode/decode acceleration; a static random access memory (SRAM) unit 1430; a direct memory access (DMA) unit 1432; and a display unit 1440 for coupling to one or more external displays.

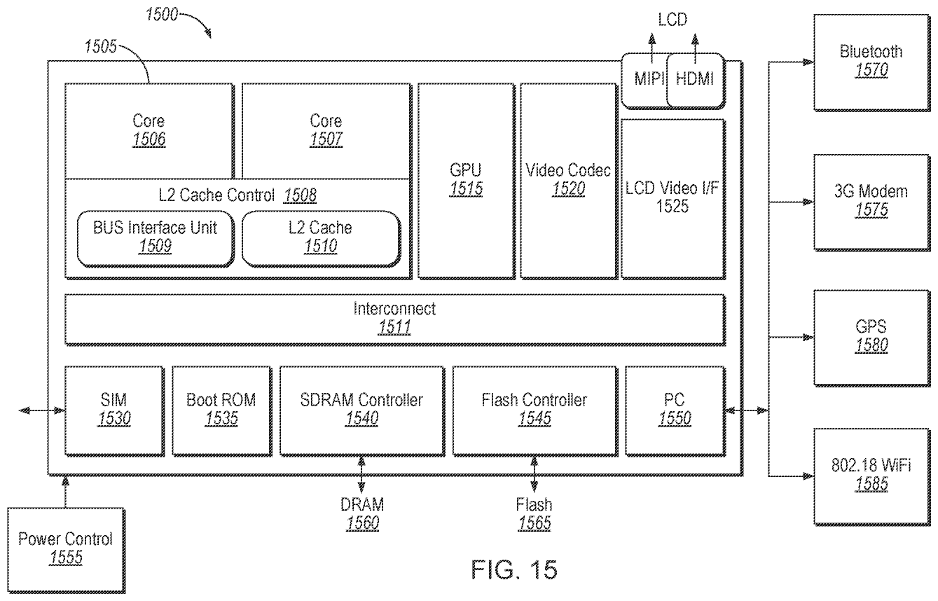

Turning next to FIG. 15, an implementation of a system on-chip (SoC) design that may implement hardware-based virtualization of an IOMMU, in accordance with implementations of the disclosure is depicted. As an illustrative example, SoC 1500 is included in user equipment (UE). In one implementation, UE refers to any device to be used by an end-user to communicate, such as a hand-held phone, smartphone, tablet, ultra-thin notebook, notebook with broadband adapter, or any other similar communication device. A UE may connect to a base station or node, which can correspond in nature to a mobile station (MS) in a GSM network. The implementations of the page additions and content copying can be implemented in SoC 1500.

Here, SoC 1500 includes 2 cores—1506 and 1507. Similar to the discussion above, cores 1506 and 1507 may conform to an Instruction Set Architecture, such as a processor having the Intel® Architecture Core™, an Advanced Micro Devices, Inc. (AMD) processor, a MIPS-based processor, an ARM-based processor design, or a customer thereof, as well as their licensees or adopters. Cores 1506 and 1507 are coupled to cache control 1508 that is associated with bus interface unit 1509 and L2 cache 1510 to communicate with other parts of system 1500. Interconnect 1511 includes an on-chip interconnect, such as an IOSF, AMBA, or other interconnects discussed above, which can implement one or more aspects of the described disclosure.

In one implementation, SDRAM controller 1540 may connect to interconnect 1511 via cache 1510. Interconnect 1511 provides communication channels to the other components, such as a Subscriber Identity Module (SIM) 1530 to interface with a SIM card, a boot ROM 1535 to hold boot code for execution by cores 1506 and 1507 to initialize and boot SoC 1500, a SDRAM controller 1540 to interface with external memory (e.g. DRAM 1560), a flash controller 1545 to interface with non-volatile memory (e.g. Flash 1565), a peripheral control 1550 (e.g. Serial Peripheral Interface) to interface with peripherals, video codecs 1520 and Video interface 1525 to display and receive input (e.g. touch enabled input), GPU 1515 to perform graphics related computations, etc. Any of these interfaces may incorporate aspects of the implementations described herein.

In addition, the system illustrates peripherals for communication, such as a Bluetooth® module 1570, 3G modem 1575, GPS 1580, and Wi-Fi® 1585. Note as stated above, a UE includes a radio for communication. As a result, these peripheral communication modules may not all be included. However, in a UE some form of a radio for external communication should be included.

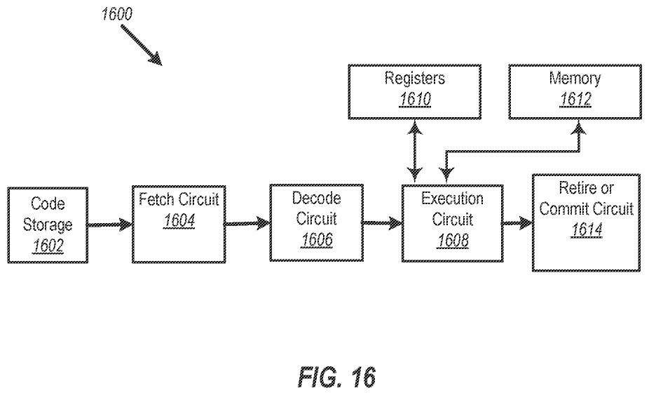

FIG. 16 is a block diagram of processing components for executing instructions that may implement hardware-based virtualization of an IOMMU. As shown, computing system 1600 includes code storage 1602, fetch circuit 1604, decode circuit 1606, execution circuit 1608, registers 1610, memory 1612, and retire or commit circuit 1614. In operation, an instruction (e.g., ENQCMDS, ADMCMDS) is to be fetched by fetch circuit 1604 from code storage 1602, which may comprise a cache memory, an on-chip memory, a memory on the same die as the processor, an instruction register, a general register, or system memory, without limitation. In one implementation, the instruction may have a format similar to that of instruction 1400 in FIG. 14. After fetching the instruction from code storage 1602, decode circuit 1606 may decode the fetched instruction, including by parsing the various fields of the instruction. After decoding the fetched instruction, execution circuit 1608 is to execute the decoded instruction. In performing the step of executing the instruction, execution circuit 1608 may read data from and write data to registers 1610 and memory 1612. Registers 1610 may include a data register, an instruction register, a vector register, a mask register, a general register, an on-chip memory, a memory on the same die as the processor, or a memory in the same package as the processor, without limitation. Memory 1612 may include an on-chip memory, a memory on the same die as the processor, a memory in the same package as the processor, a cache memory, or system memory, without limitation. After the execution circuit executes the instruction, retire or commit circuit 1614 may retire the instruction, ensuring that execution results are written to or have been written to their destinations, and freeing up or releasing resources for later use.

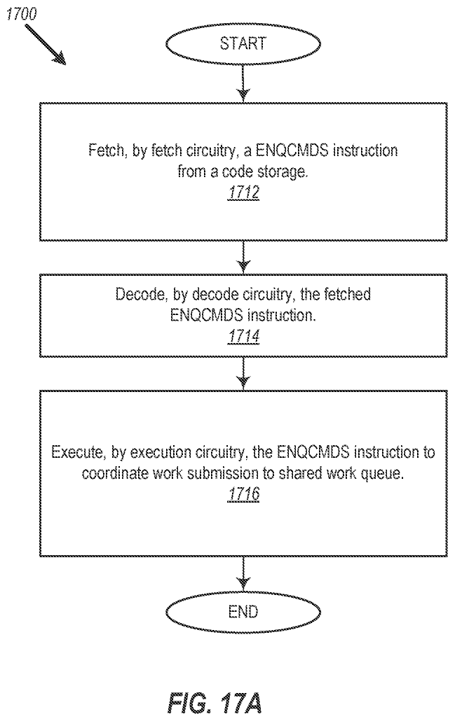

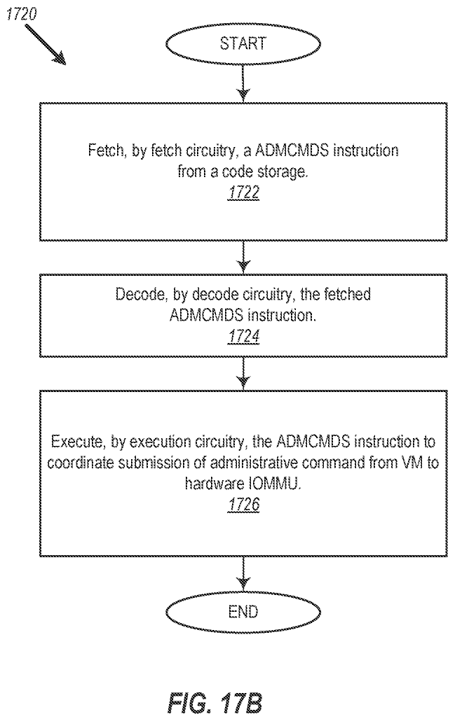

FIG. 17A is a flow diagram of an example method 1700 to be performed by a processor to execute an ENQCMDS instruction to submit work to a shared work queue (SWQ), according to one implementation. After starting the process, a fetch circuit at block 1712 is to fetch the ENQCMDS instruction from a code storage. At optional block 1714, a decode circuit may decode the fetched ENQCMDS instruction. At block 1716, an execution circuit is to execute the ENQCMDS instruction to coordinate work submission to the SWQ.

The ENQCMDS instruction is “general purpose” in the sense that, it can be used to queue work to SWQ(s) of any devices agnostic/transparent to the type of device to which the command is targeted. The ENQCMDS instruction may produce an atomic non-posted write transaction (a write transaction for which a completion response is returned back to the processing device). The non-posted write transaction may be address routed like any normal MMIO write to the target device. The non-posted write transaction may carry with it the ASID of the thread/process that is submitting this request, and also carries with it the privilege (e.g., ring-0) at which the instruction was executed on the host. The non-posted write transaction may also carries a command payload that is specific to target device. Such SWQs may be implemented with work-queue storage on the I/O device but may also be implemented using off-device (host memory) storage.

FIG. 17B is a flow diagram of an example method 1720 to be performed by a processor to execute an ADMCMDS instruction to handle invalidations from a VM with support from a hardware IOMMU. After starting the process, a fetch circuit at block 1722 is to fetch the ADMCMDS instruction from a code storage. At optional block 1724, a decode circuit may decode the fetched ADMCMDS instruction. At block 1726, an execution circuit is to execute the ADMCMDS instruction to coordinate submission of an administrative command from the VM to the hardware IOMMU 150 that includes a descriptor payload. The descriptor payload may include a host bus device function (BDF) identifier, optionally a guest ASID, a host ASID, and a guest address range to be invalidated. The hardware IOMMU 150 may then use this information to perform one or more invalidation operations.

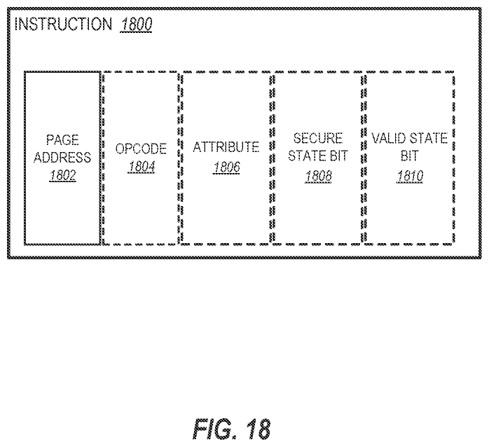

FIG. 18 is a block diagram illustrating an example format for instructions 1800 disclosed herein that implement hardware support for a multi-key cryptographic engine. The instruction 1800 may be ENQCMDS or ADMCMDS. The parameters in the format of the instruction 1800 may be different for ENQCMDS or ADMCMDS. As such, some of the parameters are depicted as optional with dashed lines. As shown, instruction 1400 includes a page address 1802, optional opcode 1804, optional attribute 1806, optional secure state bit 1808, and optional valid state bit 1810.

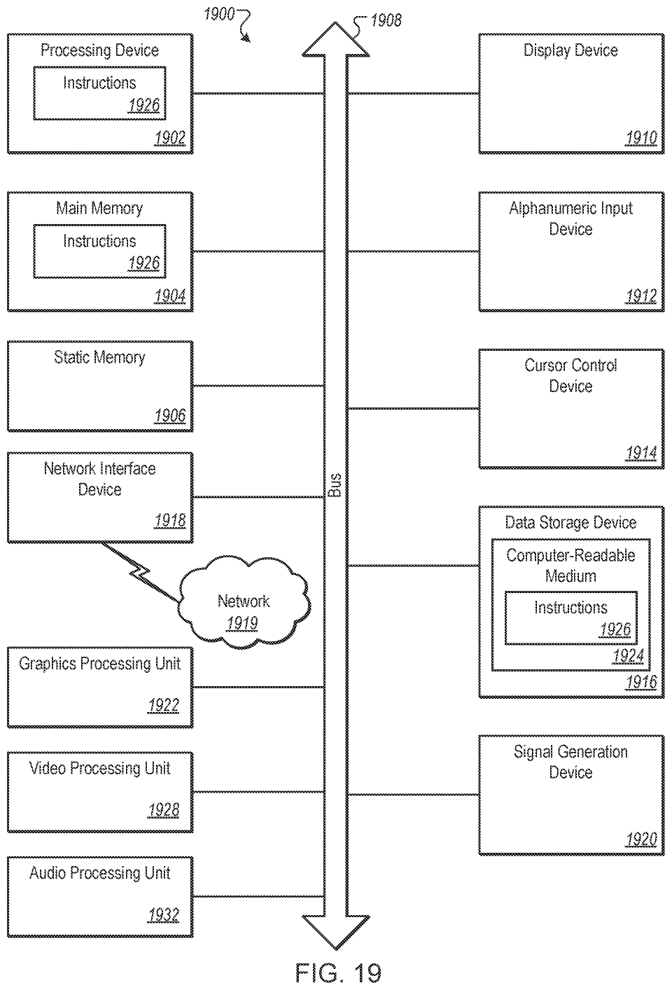

FIG. 19 illustrates a diagrammatic representation of a machine in the example form of a computing system 1900 within which a set of instructions, for causing the machine to implement hardware-based virtualization of an IOMMU according any one or more of the methodologies discussed herein. In alternative implementations, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. The implementations of the page additions and content copying can be implemented in computing system 1900.

The computing system 1900 includes a processing device 1902, main memory 1904 (e.g., flash memory, dynamic random access memory (DRAM) (such as synchronous DRAM (SDRAM) or DRAM (RDRAM), etc.), a static memory 1906 (e.g., flash memory, static random access memory (SRAM), etc.), and a data storage device 1916, which communicate with each other via a bus 1908.

Processing device 1902 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1902 may also be one or more special-purpose processing devices such as an application-specific integrated circuit (ASIC), a field programmable gate array (FPGA), a digital signal processor (DSP), network processor, or the like. In one implementation, processing device 1902 may include one or more processor cores. The processing device 1902 is configured to execute the processing logic 1926 for performing the operations discussed herein.

In one implementation, processing device 1902 can be part of a processor or an integrated circuit that includes the disclosed LLC caching architecture. Alternatively, the computing system 1900 can include other components as described herein. It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

The computing system 1900 may further include a network interface device 1918 communicably coupled to a network 1919. The computing system 1900 also may include a video display device 1910 (e.g., a liquid crystal display (LCD) or a cathode ray tube (CRT)), an alphanumeric input device 1912 (e.g., a keyboard), a cursor control device 1914 (e.g., a mouse), a signal generation device 1920 (e.g., a speaker), or other peripheral devices. Furthermore, computing system 1900 may include a graphics processing unit 1922, a video processing unit 1928 and an audio processing unit 1932. In another implementation, the computing system 1900 may include a chipset (not illustrated), which refers to a group of integrated circuits, or chips, that are designed to work with the processing device 1902 and controls communications between the processing device 1902 and external devices. For example, the chipset may be a set of chips on a motherboard that links the processing device 1902 to very high-speed devices, such as main memory 1904 and graphic controllers, as well as linking the processing device 1902 to lower-speed peripheral buses of peripherals, such as USB, PCI or ISA buses.

The data storage device 1916 may include a computer-readable storage medium 1924 on which is stored software 1926 embodying any one or more of the methodologies of functions described herein. The software 1926 may also reside, completely or at least partially, within the main memory 1904 as instructions 1926 and/or within the processing device 1902 as processing logic during execution thereof by the computing system 1900; the main memory 1904 and the processing device 1902 also constituting computer-readable storage media.

The computer-readable storage medium 1924 may also be used to store instructions 1926 utilizing the processing device 1902, and/or a software library containing methods that call the above applications. While the computer-readable storage medium 1924 is shown in an example implementation to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the disclosed implementations. The term “computer-readable storage medium” shall accordingly be taken to include, but not be limited to, solid-state memories, and optical and magnetic media.

The following examples pertain to further implementations.

Example 1 is processor comprising: 1) a hardware input/output (I/O) memory management unit (IOMMU); and 2) a core coupled to the hardware IOMMU, wherein the core is to execute a first instruction to: a) intercept a descriptor payload from a virtual machine (VM), the descriptor payload containing a guest bus device function (BDF) identifier, a guest address space identifier (ASID), and a guest address range to be invalidated; b) access, within a virtual machine control structure (VMCS) stored in memory, a first pointer to a first set of translation tables and a second pointer to a second set of translation tables; c) traverse the first set of translation tables to translate the guest BDF identifier to a host BDF identifier; d) traverse the second set of translation tables to translate the guest ASID to a host ASID; e) insert the host BDF identifier and the host ASID in the descriptor payload; and f) submit, to the hardware IOMMU, an administrative command containing the descriptor payload to perform invalidation of the guest address range.

In Example 2, the processor of Example 1, wherein the hardware IOMMU is to use the host BDF identifier and the host ASID within the descriptor payload of the administrative command to perform an invalidation operation with relation to the guest address range, wherein the invalidation operation is at least one of an I/O translation lookaside buffer (IOTLB) invalidation, a device TLB invalidation, or an ASID cache invalidation.

In Example 3, the processor of Example 2, wherein the core is to execute the first instruction to further communicate, to the VM, successful invalidation in response to completion of the invalidation operation by the hardware IOMMU.

In Example 4, the processor of Example 1, wherein the first set of tables comprises a bus table and a device-function table, wherein the bus table is indexed by a guest bus identifier, and wherein the device-function table is indexed by a guest device-function identifier.

In Example 5, the processor of Example 1, wherein the core is further to execute a guest IOMMU driver within the VM to: a) call the first instruction; b) populate the descriptor payload with the guest BDF identifier, the guest ASID, and the guest address range; and c) transmit the descriptor payload as a work submission to a shared work queue (SWQ) of the hardware IOMMU.

In Example 6, the processor of Example 5, further comprising a memory-mapped I/O (MMIO) register, wherein the guest IOMMU driver is further to access, within the MMIO register, a MMIO register address to which to submit the descriptor payload to the SWQ.

In Example 7, the processor of Example 1, wherein the first set of translation tables is stored in one of the VMCS or an on-chip memory.

Various implementations may have different combinations of the structural features described above. For instance, all optional features of the processors and methods described above may also be implemented with respect to a system described herein and specifics in the examples may be used anywhere in one or more implementations.

Example 8 is a method comprising: 1) intercepting, by a processor from a virtual machine (VM) running on the processor, a descriptor payload with a guest bus device function (BDF) identifier, a guest address space identifier (ASID), and a guest address range to be invalidated; 2) accessing, within a virtual machine control structure (VMCS) stored in memory for the VM, a first pointer to a first set of translation tables and a second pointer to a second set of translation tables; 3) traversing, by the processor, the first set of translation tables to translate the guest BDF identifier to a host BDF identifier; 4) traversing, by the processor, the second set of translation tables to translate the guest ASID to a host ASID; 5) inserting, within the descriptor payload, the host BDF identifier and the host ASID; and 6) submitting, by the processor, to a hardware IOMMU of the processor, an administrative command containing the descriptor payload, to perform invalidation of the guest address range.

In Example 9, the method of Example 8, further comprising performing, by the hardware IOMMU, an invalidation operation in relation to the guest address range using the host BDF identifier and the host ASID within the descriptor payload of the administrative command, wherein the invalidation operation is at least one of an I/O translation lookaside buffer (IOTLB) invalidation, a device TLB invalidation, or an ASID cache invalidation.

In Example 10, the method of Example 9, further comprising communicating, by the processor to the VM, successful invalidation in response to completion of the invalidation operation by the hardware IOMMU, wherein the communicating comprises setting a status bit within a completion record accessible to the VM.

In Example 11, the method of claim 8, wherein the first set of tables comprises a bus table and a device-function table, the method further comprising indexing the bus table by the guest bus identifier, and indexing the device-function table by a guest device-function identifier.

In Example 12, the method of Example 8, further comprising: 1) calling, by a guest IOMMU driver of the VM, an instruction for execution by the processor; 2) populating, by the guest IOMMU driver, the descriptor payload with the guest BDF identifier, the guest ASID, and the guest address range; and 3) transmitting, by the guest IOMMU driver, the descriptor payload to a shared work queue (SWQ) of the hardware IOMMU.

In Example 13, the method of Example 12, further comprising: 1) retrieving, from a memory-mapped I/O (MMIO) register, a MMIO register address to which to submit the descriptor payload to the SWQ; and 2) submitting the descriptor payload to the MMIO register address.

Various implementations may have different combinations of the structural features described above. For instance, all optional features of the processors and methods described above may also be implemented with respect to a system described herein and specifics in the examples may be used anywhere in one or more implementations.

Example 14 is a system comprising: 1) a hardware input/output (I/O) memory management unit (IOMMU); 2) multiple cores, coupled to the hardware IOMMU, the multiple cores to execute a plurality of virtual machines; and 3) wherein a core, of the multiple cores, is to execute a first instruction to: a) intercept a descriptor payload from a virtual machine (VM) of the plurality of virtual machines, the descriptor payload containing a guest bus device function (BDF) identifier, a guest address space identifier (ASID), and a guest address range to be invalidated; b) access, within a virtual machine control structure (VMCS) stored in memory, a first pointer to a first set of translation tables and a second pointer to a second set of translation tables; c) traverse the first set of translation tables to translate the guest BDF identifier to a host BDF identifier; d) traverse the second set of translation tables to translate the guest ASID to a host ASID; e) insert the host BDF identifier and the host ASID in the descriptor payload; and f) submit, to the hardware IOMMU, an administrative command containing the descriptor payload to perform invalidation of the guest address range. The system of Example 14 may, in a further implementation, also include the memory.

In Example 15, the system of Example 14, wherein the hardware IOMMU is to use the host BDF identifier and the host ASID within the descriptor payload of the administrative command to perform an invalidation operation with relation to the guest address range, wherein the invalidation operation is at least one of an I/O translation lookaside buffer (IOTLB) invalidation, a device TLB invalidation, or an ASID cache invalidation.

In Example 16, the system of Example 15, wherein the core is to execute the first instruction to further communicate, to the VM, successful invalidation in response to completion of the invalidation operation by the hardware IOMMU, wherein to communicate comprises to set a status bit within a completion record accessible to the guest IOMMU driver.

In Example 17, the system of Example 14, wherein the first set of tables comprises a bus table and a device-function table, wherein the bus table is indexed by a guest bus identifier, and wherein the device-function table is indexed by a guest device-function identifier.

In Example 18, the system of Example 14, wherein the core is further to execute a guest IOMMU driver within the VM to: a) call the first instruction; b) populate the descriptor payload with the guest BDF identifier, the guest ASID, and the guest address range; and c) transmit the descriptor payload to a shared work queue (SWQ) of the hardware IOMMU.

In Example 19, the system of Example 18, further comprising a memory-mapped I/O (MMIO) register, wherein the guest IOMMU driver is further to access, within the MMIO register, a MMIO register address to which to submit the descriptor payload to the SWQ.

In Example 20, the system of Example 14, wherein the first set of translation tables is stored in one of the VMCS, the memory, or an on-chip memory.

Various implementations may have different combinations of the structural features described above. For instance, all optional features of the processors and methods described above may also be implemented with respect to a system described herein and specifics in the examples may be used anywhere in one or more implementations.

Example 21 is a non-transitory computer-readable medium storing instructions, which when executed by a processor having a hardware input/output (I/O) memory management unit (IOMMU), cause the processor to execute a plurality of logic operations comprising: 1) intercepting, from a virtual machine (VM) running on the processor, a descriptor payload with a guest bus device function (BDF) identifier, a guest address space identifier (ASID), and a guest address range to be invalidated; 2) accessing, within a virtual machine control structure (VMCS) stored in memory for the VM, a first pointer to a first set of translation tables and a second pointer to a second set of translation tables; 3) traversing the first set of translation tables to translate the guest BDF identifier to a host BDF identifier; 4) traversing the second set of translation tables to translate the guest ASID to a host ASID; 5) inserting, within the descriptor payload, the host BDF identifier and the host ASID; and 6) submitting, to a hardware IOMMU of the processor, an administrative command containing the descriptor payload, to perform invalidation of the guest address range.

In Example 22, the non-transitory computer-readable medium of Example 21, wherein the plurality of logic operations further comprises performing an invalidation operation in relation to the guest address range using the host BDF identifier and the host ASID within the descriptor payload of the administrative command, wherein the invalidation operation is at least one of an I/O translation lookaside buffer (IOTLB) invalidation, a device TLB invalidation, or an ASID cache invalidation.

In Example 23, the non-transitory computer-readable medium of Example 22, wherein the plurality of logic operations further comprises communicating, to the VM, successful invalidation in response to completion of the invalidation operation by the hardware IOMMU, wherein the communicating comprises setting a status bit within a completion record accessible to the VM.

In Example 24, the non-transitory computer-readable medium of Example 21, wherein the first set of tables comprises a bus table and a device-function table, wherein the plurality of logic operations further comprises indexing the bus table by the guest bus identifier, and indexing the device-function table by a guest device-function identifier.

In Example 25, the non-transitory computer-readable medium of Example 21, wherein the plurality of logic operations further comprises: 1) calling, by a guest IOMMU driver of the VM, an instruction for execution by the processor; 2) populating, by the guest IOMMU driver, the descriptor payload with the guest BDF identifier, the guest ASID, and the guest address range; and 3) transmitting, by the guest IOMMU driver, the descriptor payload to a shared work queue (SWQ) of the hardware IOMMU.

In Example 26, the non-transitory computer-readable medium of Example 25, wherein the plurality of logic operations further comprises: 1) retrieving, from a memory-mapped I/O (MMIO) register, a MMIO register address to which to submit the descriptor payload to the SWQ; and 2) submitting the descriptor payload to the MMIO register address.

Various implementations may have different combinations of the structural features described above. For instance, all optional features of the processors and methods described above may also be implemented with respect to a system described herein and specifics in the examples may be used anywhere in one or more implementations.

Example 27 is an apparatus comprising: 1) means for intercepting, from a virtual machine (VM), a descriptor payload with a guest bus device function (BDF) identifier, a guest address space identifier (ASID), and a guest address range to be invalidated; 2) means for accessing, within a virtual machine control structure (VMCS) stored in memory for the VM, a first pointer to a first set of translation tables and a second pointer to a second set of translation tables; 3) means for traversing the first set of translation tables to translate the guest BDF identifier to a host BDF identifier; 4) means for traversing the second set of translation tables to translate the guest ASID to a host ASID; 5) means for inserting, within the descriptor payload, the host BDF identifier and the host ASID; and 6) means for submitting, to a hardware IOMMU, an administrative command containing the descriptor payload, to perform invalidation of the guest address range.

In Example 28, the apparatus of Example 27, further comprising means for performing an invalidation operation in relation to the guest address range using the host BDF identifier and the host ASID within the descriptor payload of the administrative command, wherein the invalidation operation is at least one of an I/O translation lookaside buffer (IOTLB) invalidation, a device TLB invalidation, or an ASID cache invalidation.

In Example 29, the apparatus of Example 28, further comprising means for communicating, to the VM, successful invalidation in response to completion of the invalidation operation by the hardware IOMMU, wherein the means for communicating comprises means for setting a status bit within a completion record accessible to the VM.

In Example 30, the apparatus of Example 27, wherein the first set of tables comprises a bus table and a device-function table, the apparatus further comprising means for indexing the bus table by the guest bus identifier, and means for indexing the device-function table by a guest device-function identifier.

In Example 31, the apparatus of Example 27, further comprising: 1) means for calling an instruction for execution by a processor; 2) means for populating the descriptor payload with the guest BDF identifier, the guest ASID, and the guest address range; and 3) means for transmitting the descriptor payload to a shared work queue (SWQ) of the hardware IOMMU.

In Example 32, the apparatus of Example 31, further comprising: 1) means for retrieving, from a memory-mapped I/O (MMIO) register, a MMIO register address to which to submit the descriptor payload to the SWQ; and 2) means for submitting the descriptor payload to the MMIO register address.

While the disclosure has been described with respect to a limited number of implementations, those skilled in the art will appreciate numerous modifications and variations therefrom. It is intended that the appended claims cover all such modifications and variations as fall within the true spirit and scope of this disclosure.

In the description herein, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the disclosure. It will be apparent, however, to one skilled in the art that these specific details need not be employed to practice the disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of a computer system have not been described in detail in order to avoid unnecessarily obscuring the disclosure.

The implementations are described with reference to determining validity of data in cache lines of a sector-based cache in specific integrated circuits, such as in computing platforms or microprocessors. The implementations may also be applicable to other types of integrated circuits and programmable logic devices. For example, the disclosed implementations are not limited to desktop computer systems or portable computers, such as the Intel® Ultrabooks™ computers. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. It is described that the system can be any kind of computer or embedded system. The disclosed implementations may especially be used for low-end devices, like wearable devices (e.g., watches), electronic implants, sensory and control infrastructure devices, controllers, supervisory control and data acquisition (SCADA) systems, or the like. Moreover, the apparatuses, methods, and systems described herein are not limited to physical computing devices, but may also relate to software optimizations for energy conservation and efficiency. As will become readily apparent in the description below, the implementations of methods, apparatuses, and systems described herein (whether in reference to hardware, firmware, software, or a combination thereof) are vital to a ‘green technology’ future balanced with performance considerations.

Although the implementations herein are described with reference to a processor, other implementations are applicable to other types of integrated circuits and logic devices. Similar techniques and teachings of implementations of the disclosure can be applied to other types of circuits or semiconductor devices that can benefit from higher pipeline throughput and improved performance. The teachings of implementations of the disclosure are applicable to any processor or machine that performs data manipulations. However, the disclosure is not limited to processors or machines that perform 512 bit, 256 bit, 128 bit, 64 bit, 32 bit, or 16 bit data operations and can be applied to any processor and machine in which manipulation or management of data is performed. In addition, the description herein provides examples, and the accompanying drawings show various examples for the purposes of illustration. However, these examples should not be construed in a limiting sense as they are merely intended to provide examples of implementations of the disclosure rather than to provide an exhaustive list of all possible implementations of implementations of the disclosure.

Although the above examples describe instruction handling and distribution in the context of execution units and logic circuits, other implementations of the disclosure can be accomplished by way of a data or instructions stored on a machine-readable, tangible medium, which when performed by a machine cause the machine to perform functions consistent with at least one implementation of the disclosure. In one implementation, functions associated with implementations of the disclosure are embodied in machine-executable instructions. The instructions can be used to cause a general-purpose or special-purpose processor that is programmed with the instructions to perform the steps of the disclosure. Implementations of the disclosure may be provided as a computer program product or software which may include a machine or computer-readable medium having stored thereon instructions which may be used to program a computer (or other electronic devices) to perform one or more operations according to implementations of the disclosure. Alternatively, operations of implementations of the disclosure might be performed by specific hardware components that contain fixed-function logic for performing the operations, or by any combination of programmed computer components and fixed-function hardware components.

Instructions used to program logic to perform implementations of the disclosure can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of implementations of the disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one implementation, refers to the hardware, which is specifically configured to recognize and/or execute the code to be held on a non-transitory medium. Furthermore, in another implementation, use of a module refers to the non-transitory medium including the code, which is specifically adapted to be executed by the microcontroller to perform predetermined operations. And as can be inferred, in yet another implementation, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one implementation, use of the term logic includes hardware, such as transistors, registers, or other hardware, such as programmable logic devices.

Use of the phrase ‘configured to,’ in one implementation, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ capable of/to,′ and/or ‘operable to,’ in one implementation, refers to some apparatus, logic, hardware, and/or element designed in such a way to enable use of the apparatus, logic, hardware, and/or element in a specified manner. Note as above that use of ‘to,’ capable to,′ or ‘operable to,’ in one implementation, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one implementation, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one implementation, refer to a default and an updated value or state, respectively. For example, a default value potentially includes a high logical value, i.e. reset, while an updated value potentially includes a low logical value, i.e. set. Note that any combination of values may be utilized to represent any number of states.

The implementations of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform implementations of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer)

Reference throughout this specification to “one implementation” or “an implementation” means that a particular feature, structure, or characteristic described in connection with the implementation is included in at least one implementation of the disclosure. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

In the foregoing specification, a detailed description has been given with reference to specific exemplary implementations. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of implementation and other exemplarily language does not necessarily refer to the same implementation or the same example, but may refer to different and distinct implementations, as well as potentially the same implementation.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “defining,” “receiving,” “determining,” “issuing,” “linking,” “associating,” “obtaining,” “authenticating,” “prohibiting,” “executing,” “requesting,” “communicating,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Also, the terms “first,” “second,” “third,” “fourth,” etc. as used herein are meant as labels to distinguish among different elements and may not necessarily have an ordinal meaning according to their numerical designation.

What is claimed is:

1. A processor comprising:
a hardware input/output (I/O) memory management unit (IOMMU); and
a core coupled to the hardware IOMMU, wherein the core is to execute a first instruction to:
intercept a descriptor payload from a virtual machine (VM), the descriptor payload containing a guest bus device function (BDF) identifier, a guest address space identifier (ASID), and a guest address range to be invalidated;
access, within a virtual machine control structure (VMCS) stored in memory, a first pointer to a first set of translation tables and a second pointer to a second set of translation tables;
traverse the first set of translation tables to translate the guest BDF identifier to a host BDF identifier;
traverse the second set of translation tables to translate the guest ASID to a host ASID;
insert the host BDF identifier and the host ASID in the descriptor payload; and
submit, to the hardware IOMMU, an administrative command containing the descriptor payload to perform invalidation of the guest address range.

2. The processor of claim 1, wherein the hardware IOMMU is to use the host BDF identifier and the host ASID within the descriptor payload of the administrative command to perform an invalidation operation with relation to the guest address range, wherein the invalidation operation is at least one of an I/O translation lookaside buffer (IOTLB) invalidation, a device TLB invalidation, or an ASID cache invalidation.

3. The processor of claim 2, wherein the core is to execute the first instruction to further communicate, to the VM, successful invalidation in response to completion of the invalidation operation by the hardware IOMMU.

4. The processor of claim 1, wherein the first set of tables comprises a bus table and a device-function table, wherein the bus table is indexed by a guest bus identifier, and wherein the device-function table is indexed by a guest device-function identifier.

5. The processor of claim 1, wherein the core is further to execute a guest IOMMU driver within the VM to:
call the first instruction;
populate the descriptor payload with the guest BDF identifier, the guest ASID, and the guest address range; and
transmit the descriptor payload as a work submission to a shared work queue (SWQ) of the hardware IOMMU.

6. The processor of claim 5, further comprising a memory-mapped I/O (MMIO) register, wherein the guest IOMMU driver is further to access, within the MMIO register, a MMIO register address to which to submit the descriptor payload to the SWQ.

7. The processor of claim 1, wherein the first set of translation tables is stored in one of the VMCS or an on-chip memory.

8. A method comprising:
intercepting, by a processor from a virtual machine (VM) running on the processor, a descriptor payload with a guest bus device function (BDF) identifier, a guest address space identifier (ASID), and a guest address range to be invalidated;
accessing, within a virtual machine control structure (VMCS) stored in memory for the VM, a first pointer to a first set of translation tables and a second pointer to a second set of translation tables;
traversing, by the processor, the first set of translation tables to translate the guest BDF identifier to a host BDF identifier;
traversing, by the processor, the second set of translation tables to translate the guest ASID to a host ASID;
inserting, within the descriptor payload, the host BDF identifier and the host ASID; and
submitting, by the processor, to a hardware IOMMU of the processor, an administrative command containing the descriptor payload, to perform invalidation of the guest address range.

9. The method of claim 8, further comprising performing, by the hardware IOMMU, an invalidation operation in relation to the guest address range using the host BDF identifier and the host ASID within the descriptor payload of the administrative command, wherein the invalidation operation is at least one of an I/O translation lookaside buffer (IOTLB) invalidation, a device TLB invalidation, or an ASID cache invalidation.

10. The method of claim 9, further comprising communicating, by the processor to the VM, successful invalidation in response to completion of the invalidation operation by the hardware IOMMU, wherein the communicating comprises setting a status bit within a completion record accessible to the VM.

11. The method of claim 8, wherein the first set of tables comprises a bus table and a device-function table, the method further comprising indexing the bus table by the guest bus identifier, and indexing the device-function table by a guest device-function identifier.

12. The method of claim 8, further comprising:
calling, by a guest IOMMU driver of the VM, an instruction for execution by the processor;
populating, by the guest IOMMU driver, the descriptor payload with the guest BDF identifier, the guest ASID, and the guest address range; and
transmitting, by the guest IOMMU driver, the descriptor payload to a shared work queue (SWQ) of the hardware IOMMU.

13. The method of claim 12, further comprising:
retrieving, from a memory-mapped I/O (MMIO) register, a MMIO register address to which to submit the descriptor payload to the SWQ; and
submitting the descriptor payload to the MMIO register address.

14. A system comprising:
a hardware input/output (I/O) memory management unit (IOMMU);
multiple cores, coupled to the hardware IOMMU, the multiple cores to execute a plurality of virtual machines; and
wherein a core, of the multiple cores, is to execute a first instruction to:
intercept a descriptor payload from a virtual machine (VM) of the plurality of virtual machines, the descriptor payload containing a guest bus device function (BDF) identifier, a guest address space identifier (ASID), and a guest address range to be invalidated;
access, within a virtual machine control structure (VMCS) stored in memory, a first pointer to a first set of translation tables and a second pointer to a second set of translation tables;
traverse the first set of translation tables to translate the guest BDF identifier to a host BDF identifier;
traverse the second set of translation tables to translate the guest ASID to a host ASID;
insert the host BDF identifier and the host ASID in the descriptor payload; and
submit, to the hardware IOMMU, an administrative command containing the descriptor payload to perform invalidation of the guest address range.

15. The system of claim 14, wherein the hardware IOMMU is to use the host BDF identifier and the host ASID within the descriptor payload of the administrative command to perform an invalidation operation with relation to the guest address range, wherein the invalidation operation is at least one of an I/O translation lookaside buffer (IOTLB) invalidation, a device TLB invalidation, or an ASID cache invalidation.

16. The system of claim 15, wherein the core is to execute the first instruction to further communicate, to the VM, successful invalidation in response to completion of the invalidation operation by the hardware IOMMU, wherein to communicate comprises to set a status bit within a completion record accessible to the guest IOMMU driver.

17. The system of claim 14, wherein the first set of tables comprises a bus table and a device-function table, wherein the bus table is indexed by a guest bus identifier, and wherein the device-function table is indexed by a guest device-function identifier.

18. The system of claim 14, wherein the core is further to execute a guest IOMMU driver within the VM to:
call the first instruction;
populate the descriptor payload with the guest BDF identifier, the guest ASID, and the guest address range; and
transmit the descriptor payload to a shared work queue (SWQ) of the hardware IOMMU.

19. The system of claim 18, further comprising a memory-mapped I/O (MMIO) register, wherein the guest IOMMU driver is further to access, within the MMIO register, a MMIO register address to which to submit the descriptor payload to the SWQ.

20. The system of claim 14, wherein the first set of translation tables is stored in one of the VMCS, the memory, or an on-chip memory.
